(19) United States
(12) Patent Application Publication
(10) Pub. No.: US 2026/0293980 A1
(43) Pub. Date: Oct. 1, 2026

(54) HEATER MODULE FOR AEROSOL GENERATING DEVICE AND AEROSOL GENERATING DEVICE INCLUDING THE SAME

(71) Applicant: KT&G CORPORATION, Daejeon (KR)

(72) Inventors: JONG SUB LEE, Gyeonggi-do (KR); SUN HWAN JUNG, Daejeon (KR); BYUNG SUNG CHO, Gyeonggi-do (KR)

(73) Assignee: KT&G CORPORATION, Daejeon (KR)

(21) Appl. No.: 18/881,806

(22) PCT Filed: Oct. 19, 2023
(86) PCT No.: PCT/KR2023/016288

§ 371 Date: Jan. 7, 2025

(30) Foreign Application Priority Data
Nov. 14, 2022 (KR) 10-2022-0151995
Feb. 6, 2023 (KR) 10-2023-0015718

(51) Int. Cl. A24F 40/46; A24F 40/10; A24F 40/42; A24F 40/50

(52) U.S. Cl. CPC A24F 40/46; A24F 40/10; A24F 40/42; A24F 40/50

(57) ABSTRACT

A heater module for an aerosol generating device includes a module main body including a heater accommodation groove for accommodating a heater detachably coupled to a cartridge including an aerosol generating material, and a printed circuit board (PCB) accommodation groove for accommodating a PCB unit electrically connected to an aerosol generating device, a heater terminal arranged in the module main body and electrically connected to the heater to transmit, to the heater, power from a battery included in the aerosol generating device, and a recognition terminal arranged apart from the heater terminal in the module main body and electrically connected to the PCB unit and the cartridge.

### TECHNICAL FIELD

Various embodiments of the present disclosure relate to a heater module for an aerosol generating device, the heater module having a reduced use cost and improved productivity, and an aerosol generating device including the same.

### BACKGROUND ART

Recently, there has been an increasing demand for a technology to replace the methods of supplying aerosols by burning general cigarettes. For example, research has been conducted on methods such as generating aerosols from liquid-state or solid-state aerosol generating materials, or supplying flavored aerosols by generating vapor from liquid-state aerosol generating materials and then allowing the generated vapor to pass through a solid-state flavor medium.

In particular, aerosol generating devices using liquid-state aerosol generating materials have smaller sizes than aerosol generating devices using solid-state aerosol generating materials and thus are more convenient to carry and do not generate smoking by-products and thus are convenient to use. Accordingly, interest in aerosol generating devices for generating aerosols by using liquid-state aerosol generating materials has gradually increased.

### DISCLOSURE OF INVENTION

### Technical Problem

An aerosol generating device for generating an aerosol by heating a liquid-state aerosol generating material may include a cartridge including an aerosol generating material and a heater module for heating the aerosol generating material. The heater module may be connected to the cartridge and may include a heater for heating the aerosol generating material, a heater terminal for supplying power of a battery to the heater, and a recognition terminal electrically connected to the cartridge.

In the related art, when the cartridge needs to be replaced due to depletion of the aerosol generating material in the cartridge, the heater also has to be replaced when replacing a cartridge, even when the heater has a remaining product lifespan. Thus, the overall cost of using the aerosol generating device increases.

In addition, in the related art, the structure of the heater module including the heater terminal and the recognition terminal is relatively complicated, and thus, a manufacturing process for the heater module is also complicated. Accordingly, in the related art, productivity of the aerosol generating device is lowered, and thus, a heater module having a simple manufacturing method needs to be developed.

There is a need for a new structure that may reduce a cost of using an aerosol generating device and improve productivity of the aerosol generating device. For example, there is a need for a heater module for an aerosol generating device which allow the replacement of a cartridge alone (i.e., without replacing a heater) and features a simplified manufacturing method.

The problems to be solved through embodiments are not limited to the above-described problems, and the problems not mentioned will be clearly understood by those skilled in the art to which the embodiments belong, from the description and ac-companying drawings.

### Solution to Problem

According to an aspect of the disclosure, a hear module for an aerosol generating device includes a module main body including a heater accommodation groove accommodating a heater configured to be detachably coupled to a cartridge including an aerosol generating material, and a printed circuit board (PCB) accommodation groove accommodating a PCB unit electrically connected to an aerosol generating device, a heater terminal arranged in the module main body, electrically connected to the heater, and configured to deliver power to the heater from a battery included in the aerosol generating device, and a recognition terminal arranged apart from the heater terminal in the module main body and configured to be electrically connected to the PCB unit and the cartridge. At least one of the heater terminal and the recognition terminal may be insert-injected into the module main body.

According to another aspect of the disclosure, an aerosol generating device includes the above-described heater module, a cartridge coupled to one side of the heater module and having a storage tank accommodating an aerosol generating material, and an aerosol generating device main body coupled to the other side of the heater module and having a battery configured to transmit power to the heater.

### Advantageous Effects of Invention

A heater module for an aerosol generating device and an aerosol generating device including the same, according to various embodiments of the present disclosure, may reduce overall use costs.

In addition, the heater module for an aerosol generating device and the aerosol generating device including the same, according to various embodiments of the present disclosure, may be manufactured via a simple manufacturing method, and thus, productivity thereof may be improved.

Effects according to the embodiments of the present disclosure are not limited to the above-mentioned effects, and other effects not mentioned will be clearly understood by those skilled in the art from the following description.

### BRIEF DESCRIPTION OF DRAWINGS

FIG. 1 is a perspective view of an aerosol generating device according to an embodiment.

FIG. 2 is an exploded perspective view of the aerosol generating device illustrated in FIG. 1.

FIG. 3 is a perspective view of a heater module for an aerosol generating device, according to an embodiment.

FIG. 4 is a cross-sectional perspective view of the heater module for an aerosol generating apparatus according to an embodiment, which is taken along line A-A′ of FIG. 3.

FIG. 5 is a side cross-sectional view of the heater module for an aerosol generating device according to an embodiment, which is taken along line B-B′ of FIG. 3.

FIG. 6 is a view illustrating a heater module for an aerosol generating device according to an embodiment, which is viewed from the top before a heater is assembled into a module main body.

FIG. 7 is a front cross-sectional view of the heater module for an aerosol generating device according to an embodiment, which is taken along line C-C′ of FIG. 6.

FIG. 8 is a side cross-sectional view of the heater module for an aerosol generating device according to an embodiment, which is taken along line D-D′ of FIG. 6.

FIG. 9 is a view illustrating a heater module for an aerosol generating device according to an embodiment, which is viewed from the bottom before a printed circuit board (PCB) unit is assembled into a module main body.

FIG. 10 is a schematic side cross-sectional view of a heater module for an aerosol generating device according to an embodiment.

FIGS. 11A to 11C are views illustrating a process in which a heater is inserted into a heater accommodation groove, according to an embodiment.

FIG. 12 is a schematic side cross-sectional view of a heater module for an aerosol generating device according to an embodiment, which is for describing another example of a heater terminal.

FIGS. 13A to 13C are views illustrating a process in which a heater is inserted into a heater accommodation groove, according to another embodiment.

FIG. 14 is a view illustrating a recognition terminal arranged inside a heater module for an aerosol generating device, according to an embodiment.

FIG. 15 is a schematic side cross-sectional view of the heater module for an aerosol generating device according to an embodiment, which is taken along line E-E′ of FIG. 14 to describe an example of a recognition terminal.

FIG. 16 is a schematic front cross-sectional view of the heater module for an aerosol generating device according to an embodiment, which is taken along line F-F′ of FIG. 14 to describe an example of a recognition terminal.

FIG. 17 is a block diagram of an aerosol generating device according to another embodiment.

### BEST MODE FOR CARRYING OUT THE INVENTION

A heater module for an aerosol generating device according to an embodiment may include a module main body including a heater accommodation groove accommodating a heater detachably coupled to a cartridge including an aerosol generating material, and a printed circuit board (PCB) accommodation groove accommodating a PCB unit electrically connected to an aerosol generating device, a heater terminal arranged in the module main body, and electrically connected to the heater to transmit, to the heater, power from a battery included in the aerosol generating device, and a recognition terminal arranged in the module main body at a location spaced apart from the heater terminal, and electrically connected to the PCB unit and the cartridge. At least one of the heater terminal and the recognition terminal may be insert-injected into the module main body.

The module main body may include a recognition terminal accommodation portion accommodating the recognition terminal, and a waterproof partition wall separating the heater accommodation groove from the recognition terminal accommodation portion.

One side of the heater terminal may be arranged on a chamber in which an aerosol is generated and which is connected to the heater accommodation groove, and is electrically connected to the heater, and the other side of the heater terminal extends in one direction and passes through the module main body to be electrically connected to the battery.

The heater terminal may include a first heater terminal element in contact with the heater, a second heater terminal element connected to the first heater terminal element, and a third heater terminal element connected to the second heater terminal element and coupled to the module main body.

A portion of at least one of the first heater terminal element and the second heater terminal element may include a curved surface.

The first heater terminal element may be connected to the second heater terminal element to elastically move.

A portion of the second heater terminal element facing the heater accommodation groove may be inclined.

The third heater terminal element may be arranged to be spaced apart from an inner surface of the module main body.

The heater terminal may further include a fourth heater terminal element connected to the third heater terminal element and extending in a direction crossing a direction in which the third heater terminal element extends.

The first heater terminal element may protrude toward the heater accommodation groove.

The recognition terminal may include a cartridge contact element in contact with the cartridge, a recognition terminal main body connected to the cartridge contact element, and a PCB contact element connected to the recognition terminal main body and the PCB unit.

The cartridge contact element may be arranged to surround a portion of the recognition terminal main body.

The PCB contact element may include a portion protruding toward the PCB unit.

The PCB unit may include a PCB substrate with which the recognition terminal is in contact, and a memory chip arranged on the PCB substrate, and the PCB accommodation groove may include a first accommodation groove accommodating the PCB substrate and a second accommodation groove accommodating the memory chip.

An aerosol generating device according to an embodiment may include a heater module for an aerosol generating device, a cartridge coupled to one side of the heater module for an aerosol generating device and having a storage tank accommodating an aerosol generating material, and an aerosol generating device main body coupled to the other side of the heater module for an aerosol generating device and having a battery configured to transmit power to the heater.

### MODE FOR THE INVENTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, when an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the present disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and generated aerosols may be delivered to a user through a cigarette. In other words, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. At this time, the ultrasonic vibration method may mean a method of generating aerosols by converting an aerosol generating material into aerosols with ultrasonic vibration generated by a vibrator.

The aerosol generating device may include a vibrator, and generate a short-period vibration through the vibrator to convert an aerosol generating material into aerosols. The vibration generated by the vibrator may be ultrasonic vibration, and the frequency band of the ultrasonic vibration may be in a frequency band of about 100 kHz to about 3.5 MHz, but is not limited thereto.

The aerosol generating device may further include a wick that absorbs an aerosol generating material. For example, the wick may be arranged to surround at least one area of the vibrator, or may be arranged to contact at least one area of the vibrator.

As a voltage (for example, an alternating voltage) is applied to the vibrator, heat and/ or ultrasonic vibrations may be generated from the vibrator, and the heat and/or ultrasonic vibrations generated from the vibrator may be transmitted to the aerosol generating material absorbed in the wick. The aerosol generating material absorbed in the wick may be converted into a gaseous phase by heat and/or ultrasonic vibrations transmitted from the vibrator, and as a result, aerosols may be generated.

For example, the viscosity of the aerosol generating material absorbed in the wick may be lowered by the heat generated by the vibrator, and as the aerosol generating material having a lowered viscosity is granulated by the ultrasonic vibrations generated from the vibrator, aerosols may be generated, but is not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the susceptor may be a magnetic body that generates heat by an external magnetic field. As the susceptor is positioned inside the coil and a magnetic field is applied to the susceptor, the susceptor generates heat to heat an aerosol generating article. In addition, optionally, the susceptor may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in a form that can be implemented in the aerosol generating devices of the various embodiments described above or may be implemented in various different forms, and is not limited to the embodiments described herein.

Hereinafter, embodiments of the present disclosure will be described in detail with reference to the drawings.

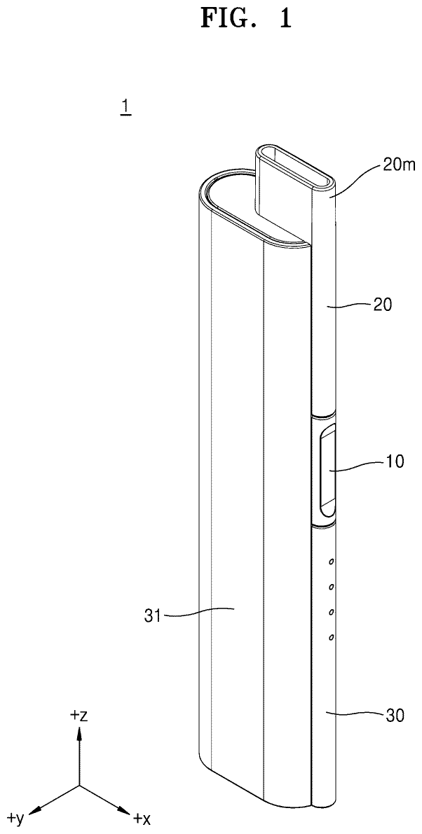

FIG. 1 is a perspective view of an aerosol generating device according to an embodiment.

Referring to FIG. 1, an aerosol generating device 1 according to an embodiment may include a heater module 10 for an aerosol generating device, a cartridge 20, and an aerosol generating device main body 30.

The heater module 10 for an aerosol generating device may be located between the cartridge 20 and the aerosol generating device main body 30 and may perform a function of generating an aerosol by converting an aerosol generating material into a gaseous phase. The heater module 10 for an aerosol generating device may generate an aerosol by heating an aerosol generating material supplied from the cartridge 20.

For example, the heater module 10 for an aerosol generating device may generate vapor from the aerosol generating material by heating the aerosol generating material supplied from the cartridge 20, and the generated vapor may be mixed with external air introduced into the heater module 10 for an aerosol generating device from the outside of the heater module 10 for an aerosol generating device. Accordingly, an aerosol may be generated. In the present disclosure, the term “aerosol” may refer to particles generated by mixing vapor generated by heating an aerosol generating material with air.

The aerosol generating material may be stored inside the cartridge 20, and the aerosol generating material stored in the cartridge 20 may be supplied to the heater module 10 for an aerosol generating device, which is arranged at a lower end of the cartridge 20 (e.g., a portion facing a −z direction).

According to an embodiment, the cartridge 20 may include a mouthpiece 20m for supplying an aerosol to a user. For example, the mouthpiece 20m may provide fluid communication between the inside of the heater module 10 to the outside of the heater module 10. An aerosol generated inside the heater module 10 may be discharged to the outside of the aerosol generating device 1 via the mouthpiece 20m. Here, the user may contact the mouthpiece 20m with the mouth and inhale the aerosol discharged to the outside of the aerosol generating device 1.

The aerosol generating device main body 30 may be located at a lower end (e.g., a portion facing the-z direction) of the heater module 10 for an aerosol generating device and support the heater module 10 for an aerosol generating device. The components for an operation of the aerosol generating device 1 may be arranged inside the aerosol generating device main body 30. For example, a battery (not shown) and a processor (not shown) may be arranged inside the aerosol generating device main body 30. However, the battery and the processor are only examples of components arranged inside the aerosol generating device main body 30, and other components (e.g., a user interface, a sensor, and the like) may be further arranged inside the aerosol generating device main body 30, in addition to the components described above.

According to an embodiment, the aerosol generating device 1 may further include a cover 31 for protecting the components of the aerosol generating device 1.

The cover 31 may be arranged to surround, at least partially, the heater module 10, the cartridge 20, and the aerosol generating device main body 30 to fix locations of the heater module 10, the cartridge 20, and the aerosol generating main body 30 and to protect the heater module 10, the cartridge 20, and the aerosol generating device main body 30 from external impact or inflow of foreign materials.

According to an embodiment, the cover 31 may be integrally formed with the aerosol generating device main body 30, but is not limited thereto. In an embodiment, the cover 31 may be detachably coupled to the aerosol generating device main body 30.

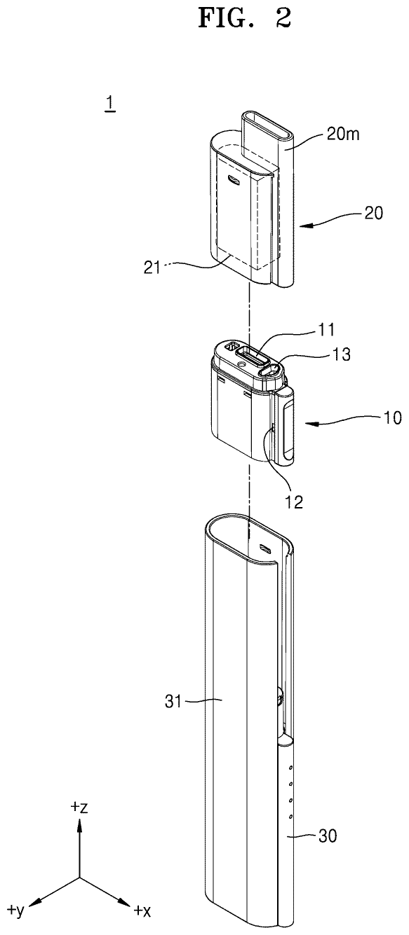

Hereinafter, a coupling relationship among the heater module 10, the cartridge 20, and the aerosol generating device main body 30 is described in detail with reference to FIG. 2.

FIG. 2 is an exploded perspective view of the aerosol generating device illustrated in FIG. 1.

Referring to FIG. 2, an aerosol generating device 1 according to an embodiment may include a heater module 10, a cartridge 20, an aerosol generating device main body 30, and a cover 31. At least one of components of the aerosol generating device 1 may be the same as or similar to at least one of the components of the aerosol generating device 1 shown in FIG. 1, and the same description thereof is omitted below.

In addition, the components of the aerosol generating device 1 are not limited thereto, and according to embodiments, at least one of the components described above (e.g., the cover 31) may be omitted or other components may be added.

The heater module 10 may be detachably coupled to a bottom surface of the cartridge 20 (e.g., a surface facing a-z direction), and may generate an aerosol by heating an aerosol generating material supplied from a storage tank 21 of the cartridge 20.

For example, a first coupling element (not shown) arranged in one area of the heater module 10 facing the cartridge 20 may be coupled to or decoupled from a second coupling element (not shown) arranged on the bottom surface of the cartridge 20, and accordingly the heater module 10 may be coupled to or detached from the cartridge 20. However, the coupling method between the cartridge 20 and the heater module 10 is not limited thereto.

When the aerosol generating material stored in the storage tank 21 of the cartridge 20 is depleted, a user may continue smoking by replacing an existing cartridge 20 with a new cartridge 20. As another example, when performance of a component (e.g., a heater or a wick) of the heater module 10 is degraded and a sufficient amount of aerosol is not generated, the user may replace an existing heater module 10 with a new heater module 10 so that a sufficient amount of aerosol is generated.

When the cartridge 20 needs to be replaced due to consumption of the aerosol generating material stored in the storage tank 21 of the cartridge 20, the aerosol generating device 1 according to an embodiment may be implemented in a structure in which only the cartridge 20 is replaced and the heater module 10 is reusable. In other words, the heater module 10 according to an embodiment may be detachably coupled to the cartridge 20, and thus may be reused without being replaced even if the cartridge 20 needs to be replaced. Thus, the overall cost of using the aerosol generating device 1 according to the embodiment may be reduced.

According to an embodiment, the heater module 10 may include an aerosol generating material inlet 11 for connecting the inside of the heater module 10 to the inside of the storage tank 21, an air inlet 12 for introducing external air into the heater module 10, and an air outlet 13 for discharging an aerosol generated inside the heater module 10 to the outside.

The aerosol generating material stored in the storage tank 21 of the cartridge 20 may flow into the heater module 10 through the aerosol generating material inlet 11, and the heater arranged inside the heater module 10 may heat the aerosol generating material supplied from the storage tank 21. Detailed descriptions of the components arranged inside the heater module 10 are given below.

External air may be introduced into the heater module 10 through the air inlet 12, and inside the heater module 10, an aerosol may be generated by the introduced external air mixed with vapor that is generated by heating the aerosol generating material.

The aerosol generated inside the heater module 10 may flow from the heater module 10 10 into the cartridge 20 through the air outlet 13 that is arranged in one area of the heater module 10 and faces the cartridge 20, and then be discharged to the outside of the aerosol generating device 1 through the mouthpiece 20m. For example, when pressure inside the cartridge 20 decreases by inhalation of the user through the mouthpiece 20m, air and/or aerosol inside the heater module 10 may move from the heater module 10 into the cartridge 20, and the user may inhale the air and/or aerosol moved into the cartridge 20.

The cartridge 20 may include the storage tank 21 that stores the aerosol generating material.

When the cartridge 20 is coupled to the heater module 10, the storage tank 21 may be connected or fluidly connected to an inner space of the heater module 10, and as a result, the aerosol generating material stored in the storage tank 21 may flow into the inner space of the heater module 10.

Here, the aerosol generating material stored in the storage tank 21 may include a tobacco-containing material having a volatile tobacco flavor component, or a liquid composition including a non-tobacco material.

According to an embodiment, the liquid composition may include one component of water, solvents, ethanol, plant extracts, spices, flavorings, and vitamin mixtures, or a mixture of these components. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. In addition, the liquid composition may include an aerosol forming agent such as glycerin and propylene glycol.

For example, the liquid composition may include any weight ratio of glycerin and propylene glycol solution to which nicotine salts are added. The liquid composition may include two or more types of nicotine salts. Nicotine salts may be formed by adding suitable acids, including organic or inorganic acids, to nicotine. Nicotine may be a naturally generated nicotine or synthetic nicotine and may have any suitable weight concentration relative to the total solution weight of the liquid composition.

Acid for the formation of the nicotine salts may be appropriately selected by considering a rate of nicotine absorption in the blood, an operating temperature of the aerosol generating device 1, the flavor or savor, the solubility, or the like. For example, the acid for the formation of nicotine salts may be a single acid selected from the group consisting of benzoic acid, lactic acid, salicylic acid, lauric acid, sorbic acid, levulinic acid, pyruvic acid, formic acid, acetic acid, propionic acid, butyric acid, valeric acid, caproic acid, caprylic acid, capric acid, citric acid, myristic acid, palmitic acid, stearic acid, oleic acid, linoleic acid, linolenic acid, phenylacetic acid, tartaric acid, succinic acid, fumaric acid, gluconic acid, saccharic acid, malonic acid or malic acid, or a mixture of two or more acids selected from the group, but is not limited thereto.

The aerosol generating device main body 30 may be detachably coupled to a bottom surface (e.g., a surface facing the-z direction) of the heater module 10 to support the heater module 10. For example, the aerosol generating device main body 30 may be detachably coupled to the heater module 10 by at least one area of the aerosol generating device main body 30 being inserted into an insertion groove formed in the bottom surface of the heater module 10. However, the coupling method between the heater module 10 and the aerosol generating device main body 30 is not limited thereto.

According to an embodiment, components for an operation of the aerosol generating device 1 may be arranged inside the aerosol generating device main body 30. For example, a battery (not shown) for supplying power and a processor (not shown) for controlling the operation of the aerosol generating device 1 may be arranged inside the aerosol generating device main body 30.

The battery may supply power used for the operation of the aerosol generating device 1. For example, the battery may be electrically connected to the heater module 10 to supply power so that the heater of the heater module 10 may be heated. As another example, the battery may also supply power needed for operations of other components (e.g., the processor, and the like) of the aerosol generating device 1.

The processor may control the overall operation of the aerosol generating device 1. The processor may be implemented as an array of a plurality of logic gates or may be implemented as a combination of a general purpose microprocessor and a memory in which a program executable in the microprocessor is stored, but is not limited thereto.

According to an embodiment, the processor may control power supplied from the battery to the heater of the heater module 10. For example, the processor may control an amount of power supplied from the battery to the heater and the time during which power is supplied from the battery to the heater so that the heater of the heater module 10 may be heated to a certain temperature or may maintain a predefined temperature.

The aerosol generating device 1 according to an embodiment may enable re-placement of the cartridge 20 and/or the heater module 10 via a structure in which the cartridge 20 is detachably coupled to the heater module 10 and the heater module 10 is detachably coupled to the aerosol generating device main body 30.

Hereinafter, the components of the heater module 10 according to an embodiment are described in detail.

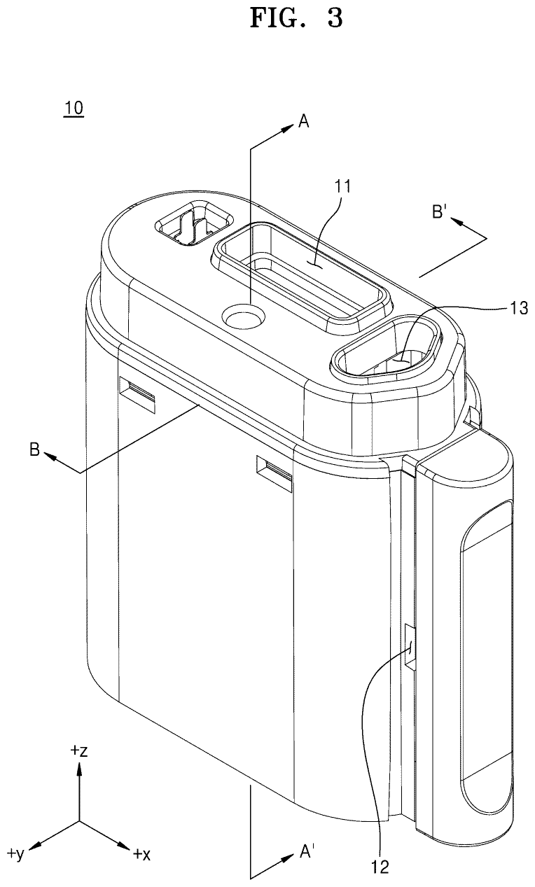

FIG. 3 is a perspective view of a heater module for an aerosol generating device, according to an embodiment.

A heater module 10 illustrated in FIG. 3 may be an embodiment of the heater module 10 of the aerosol generating device 1 of FIG. 1 and FIG. 2, and thus, the same descriptions thereof are omitted below.

Referring to FIG. 3, the heater module 10 according to an embodiment may include an aerosol generating material inlet 11, an air inlet 12, and an air outlet 13.

The aerosol generating material inlet 11 may operate to introduce an aerosol generating material supplied from the cartridge 20 into the heater module 10. For example, the aerosol generating material inlet 11 may be arranged in one area (e.g., an area facing a +z direction) of the heater module 10, which is coupled to the cartridge 20, and the aerosol generating material stored in the storage tank 21 of the cartridge 20 may pass through the aerosol generating material inlet 11 and flow into the heater module 10.

The air inlet 12 may operate to introduce air (hereinafter, external air) outside the heater module 10 into the heater module 10. For example, the air inlet 12 may be arranged in another area of the heater module 10 (e.g., on a side surface of the heater module 10) apart from the aerosol generating material inlet 11, and the external air may pass through the air inlet 12 and flow into the heater module 10.

The external air introduced into the heater module 10 may move or flow along an air flow passage arranged inside the heater module 10 into a chamber in which an aerosol is generated, and a detailed description thereof is given below.

The air outlet 13 may operate to discharge the aerosol and/or air generated inside the heater module 10 to the outside of the heater module 10 or to the cartridge 20. For example, the air outlet 13 may be spaced apart from the aerosol generating material inlet 11 in one area of the heater module 10, which is coupled to the cartridge 20. The aerosol and/or air inside the heater module 10 may be discharged to the outside of the heater module 10 through the air outlet 13.

The aerosol and/or air, which are discharged to the outside of the heater module 10 through the air outlet 13 while the cartridge 20 is coupled to the heater module 10, may be introduced into the cartridge 20 and then discharged to the outside of the cartridge 20 through the mouthpiece 20m by an inhalation action of a user.

In an example, when a portion of the heater module 10 is inserted into the cartridge 20, a first coupling element (not shown) of the heater module 10 and a second coupling element (not shown) of the cartridge 20 may be coupled to each other. In another example, when a force in a direction away from the heater module 10 is applied to the cartridge 20 while the heater module 10 and the cartridge 20 are coupled to each other, the coupling between the first coupling element (not shown) and the second coupling element (not shown) may be released, and thus, the cartridge 20 may be detached from the heater module 10.

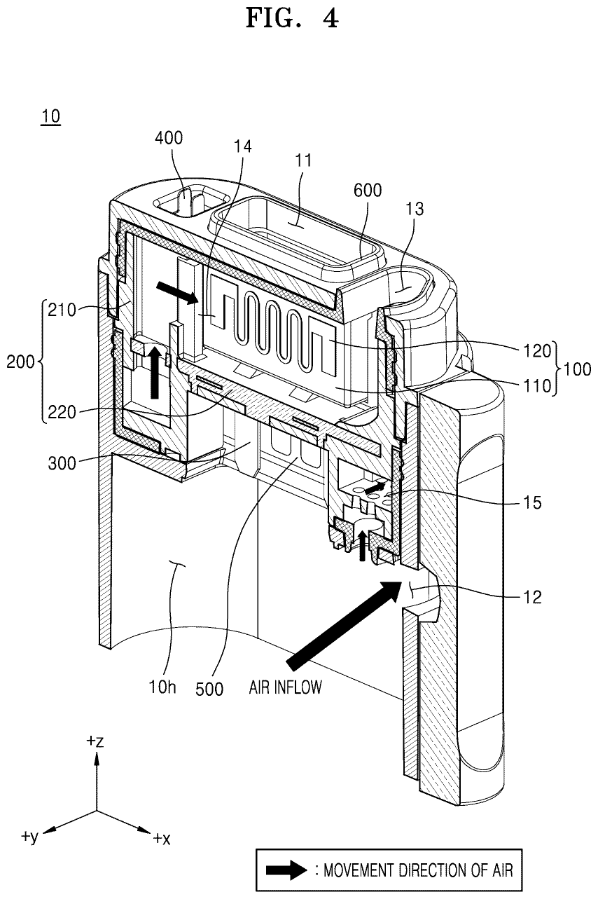

FIG. 4 is a cross-sectional perspective view of a heater module for an aerosol generating device according to an embodiment, which is taken along line A-A′ of FIG. 3. The thick arrows illustrated in FIG. 4 indicate a movement direction of air (or external air).

Referring to FIG. 4, a heater module 10 according to an embodiment may include an aerosol generating material inlet 11, an air inlet 12, an air outlet 13, a chamber 14, and an air flow passage 15. At least one of components of the heater module 10 according to one embodiment may be the same as or similar to at least one of the components of the heater module 10 shown in FIG. 3, and the same description thereof is omitted below.

The chamber 14 (or an aerosol generating chamber) may be formed in an inner space of the heater module 10. In the chamber 14, an aerosol generating material, which is introduced from the storage tank 21 of the cartridge 20, may be heated to generate an aerosol.

The chamber 14 may be in fluid communication with the storage tank 21 of the cartridge 20 through the aerosol generating material inlet 11, and the aerosol generating material, which is stored in the storage tank 21 of the cartridge 20, may pass through the aerosol generating material inlet 11 and flow into the chamber 14.

The air flow passage 15 may perform a function of allowing air introduced through the air inlet 12 to flow into the heater module 10. One area of the air flow passage 15 may be formed by extending along an edge of the heater module 10 inside the heater module 10, and external air, which is introduced into the heater module 10 through the air inlet 12, may reach the inside of the chamber 14 along the one area of the air flow passage 15.

Vapor, which is generated when the aerosol generating material is heated by a heater 100, may be mixed with the external air introduced into the chamber 14 along the air flow passage 15, and as a result, an aerosol may be generated in one area adjacent to a side surface of a wick 110 arranged within the chamber 14. The generated aerosol and/ or external air may be discharged to the outside of the heater module 10 through the air outlet 13.

According to an embodiment, the heater module 10 may include an insertion groove 10h into which at least a portion of the aerosol generating device main body 30 is inserted.

The insertion groove 10h may be formed in an area (e.g., an area facing a −z direction) of the heater module 10, which is coupled to the aerosol generating device main body 30. When at least the portion of the aerosol generating device main body 30 is inserted into the insertion groove 10h, the heater module 10 may be coupled to the aerosol generating device main body 30. For example, the heater module 10 may be coupled to the aerosol generating device main body 30 in a way that at least the portion of the aerosol generating device main body 30 is fitted into the insertion groove 10h by interference fit, but the coupling method is not limited thereto.

Referring to FIG. 4, the heater module 10 according to an embodiment may further include the heater 100, a module main body 200, a heater terminal 300, a recognition terminal 400, a printed circuit board (PCB) unit 500, and an upper cover 600.

However, the components of the heater module 10 according to the embodiment are not limited thereto, and components according to the embodiment may be added or at least one component may be omitted.

The heater 100 may be located inside the module main body 200 and heat the aerosol generating material introduced through the aerosol generating material inlet 11 to generate an aerosol. When the heater module 10 according to an embodiment is detachably coupled to the cartridge 20, the heater 100 may also be detachably coupled to the cartridge 20. Therefore, as described above, the aerosol generating device 1 according to an embodiment may be implemented in a structure in which only the cartridge 20 is replaced and the heater module 10 including the heater 100 is reusable, if the aerosol generating material in the storage tank 21 of the cartridge 20 is depleted.

The heater 100 may include the wick 110 and a heating unit 120.

The wick 110 may be arranged in one area inside the chamber 14, which is adjacent to the aerosol generating material inlet 11, to absorb the aerosol generating material which passes through the aerosol generating material inlet 11 and flows into the chamber 14.

For example, at least one area of the wick 110 may be arranged to face the aerosol generating material inlet 11 to absorb the aerosol generating material which passes through the aerosol generating material inlet 11 and flows into the chamber 14.

According to an embodiment, the wick 110 may include ceramic fiber or porous ceramic for absorbing the aerosol generating material. In other words, the wick 110 may be a ceramic wick. However, the wick 110 is not limited to the embodiment described above, and according to embodiments, the wick 110 may be formed of another material (e.g., cotton, glass, or the like).

The heater module 10 according to an embodiment may further include a support element arranged inside the chamber 14. The support element may fix a location of the wick 110 inside the chamber 14. As such, the wick 110 may stably absorb the aerosol generating material even when the heater module 10 tilts or shakes during use of the aerosol generating device 1.

The heating unit 120 may be arranged on one side surface of the wick 110 (e.g., one side surface facing a +y direction) to heat the aerosol generating material absorbed into the wick 110. For example, the heating unit 120 may heat the aerosol generating material absorbed into the wick 110 by using power supplied from the battery of the aerosol generating device main body 30.

The heating unit 120 may include a metal material that generates heat by electrical resistance. For example, the heating unit 120 may include stainless steel not to be corroded by the aerosol generating material absorbed into the wick 110, but the metal material of the heating unit 120 is not limited thereto. In another example, the heating unit 120 may include a metal material such as copper, nickel, or tungsten.

According to an embodiment, the heating unit 120 may include a conductive pattern printed on one side surface of the wick 110. For example, the heating unit 120 may be formed in a way that a metal material (e.g., stainless steel) is printed on the side surface of the wick 110 facing the +y direction to have a certain pattern shape, but is not limited thereto.

According to an embodiment, the heating unit 120 may include a conductive pattern that is insert-injected into one side surface of the wick 110. For example, the heating unit 120 may be formed in a way that a metal material (e.g., stainless steel) is insert-injected into the side surface of the wick 110 facing the +y direction in a certain pattern shape, but the method by which the heating unit 120 is formed or the shape of the heating unit 120 is not limited to the embodiment described above.

Although not illustrated in the drawings, according to an embodiment, the heating unit 120 may include a conductive plate arranged on one side surface of the wick 110.

The heating unit 120 may be arranged on the side surface of the wick 110, and thus, vapor may be generated by heating the aerosol generating material in one area of the chamber 14 adjacent to the side surface of the wick 110. The vapor generated from the aerosol generating material may be mixed with air introduced into the chamber 14 through the air inlet 12.

Here, the external air may flow into the heater module 10 through the air inlet 12, and then move along the air flow passage 15 and move into the chamber 14. The air flow passage 15 may connect the air inlet 12 to the air outlet 13 and may form a flow path through which external air and/or aerosol move.

The module main body 200 may be arranged inside the heater module 10 according to an embodiment and accommodate the heater 100, the heater terminal 300, the recognition terminal 400, and the PCB unit 500. The module main body 200 may perform a function of supporting the heater 100, the heater terminal 300, the recognition terminal 400, and the PCB unit 500, and may function as a main body of the heater module 10 according to an embodiment. The module main body 200 may include a groove for accommodating the heater 100, the heater terminal 300, the recognition terminal 400, and the PCB unit 500, and a detailed description thereof is given below.

The module main body 200 may include a first module main body 210 and a second module main body 220.

The first module main body 210 may be a portion of the module main body 200, which surrounds a side surface of the heater 100. The aerosol generating material inlet 11 and the air outlet 13 may be formed in the first module main body 210.

The second module main body 220 may be a portion of the module main body 200, which supports a lower surface of the heater 100 (e.g., a surface facing a-z direction). The chamber 14 described above may be formed on the second module main body 220 (e.g., a portion facing a +z direction) and inside the first module main body 210.

Although not shown in FIG. 4, the second module main body 220 may include therein a through hole through which the heater terminal 300 and the recognition terminal 400 pass. In an embodiment, the second module main body 220 may be integrally formed with the first module main body 210 or may be detachably coupled to the first module main body 210.

The heater terminal 300 may be arranged in the module main body 200 to transmit, to the heater 100, power generated from the battery included in the aerosol generating device 1. To this end, the heater terminal 300 may be electrically connected to the heating unit 120 of the heater 100 and the battery. The heater terminal 300 may include a metal material (e.g., copper), but the material thereof is not limited thereto.

One side of the heater terminal 300 may contact the heating unit 120 of the heater 100. Although not illustrated in FIG. 4, one side of the heater terminal 300 may be arranged on one side surface of the heater 100 (e.g., one surface facing the +y direction) inside the chamber 14 to contact the heating unit 120. The one side of the heater terminal 300 may extend upwards from one surface of the second module main body 220 (e.g., a surface facing the +z direction).

The other side of the heater terminal 300 may be electrically connected to the battery of the aerosol generating device 1. As an example, the other side of the heater terminal 300 may be directly connected to the battery or may be indirectly connected to the battery through a connection contact (not shown) connected to the battery. Accordingly, the heater terminal 300 may transmit power, which is generated from the battery, to the heating unit 120. The other side of the heater terminal 300 may extend downwards from the lower surface of the second module main body 220 (e.g., a surface facing the −z direction) and may be spaced apart from the PCB unit 500.

The recognition terminal 400 may be arranged in the module main body 200 at a location spaced apart from the heater terminal 300, and may be electrically connected to the PCB unit 500 and the cartridge 20. Accordingly, the recognition terminal 400 may be in direct contact with the PCB unit 500 and the cartridge 20, but the contact method thereof is not limited thereto. In addition, the recognition terminal 400 may include a metal material (e.g., copper), but the material thereof is not limited thereto.

In an embodiment, the recognition terminal 400 may perform a function of recognizing whether or not the cartridge 20 is connected to the heater module 10. For example, when the cartridge 20 is connected to the heater module 10, the recognition terminal 400 may transmit connection information to the aerosol generating device 1 (e.g., to a memory or a processor of the aerosol generating device 1).

In an embodiment, the recognition terminal 400 may perform a function of keeping the cartridge 20 coupled to the heater module 10. In other words, the recognition terminal 400 may serve as the first coupling element described above.

One side of the recognition terminal 400 may contact the cartridge 20 and extend upwards from an upper surface of the second module main body 220 (e.g., a surface facing the +z direction).

The other side of the recognition terminal 400 may contact the PCB unit 500 and extend downwards from a lower surface of the second module main body 220 (e.g., a surface facing the −z direction).

The PCB unit 500 may be arranged in the module main body 200 at a location spaced apart from the heater 100. In an embodiment, when the heater 100 is arranged on one side of the module main body 200 (e.g., a region in the +z direction from the second module main body 220), the PCB unit 500 may be arranged on the opposite side of the module main body 200 (e.g., a region in the −z direction from the second module main body 220).

According to an embodiment, the PCB unit 500 may function as an intermediate medium for an electrical connection (e.g., information communication transmission) between the cartridge 20 and the aerosol generating device main body 30. In other words, the cartridge 20 may be electrically connected to the PCB unit 500 through the recognition terminal 400, and the PCB unit 500 may be electrically connected to the connection contact (not shown) within the aerosol generating device main body 30, and thus, the cartridge 20 and the aerosol generating device main body 30 may be electrically connected to each other.

The upper cover 600 is coupled to an upper portion of the module main body 200. The upper cover 600 may be detachably coupled to the module main body 200 or may be integrally formed with the module main body 200. The aerosol generating material inlet 11 and the air outlet 13 described above may be formed in the upper cover 600.

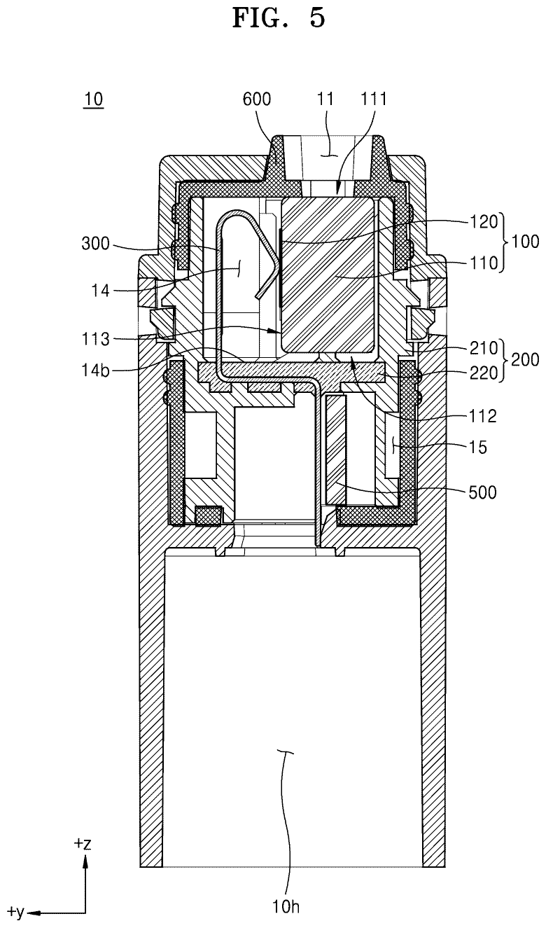

FIG. 5 is a side cross-sectional view of the heater module according to an embodiment, which is taken along line B-B′ of FIG. 3.

Referring to FIG. 5, a heater module 10 according to an embodiment may include a chamber 14, an air flow passage 15, a heater 100, a module main body 200, a heater terminal 300, and a PCB unit 500. The heater module 10 according to an embodiment illustrated in FIG. 5 may be substantially the same as or similar to the heater module 10 illustrated in FIG. 4, and the same description is omitted below.

A wick 110 for absorbing an aerosol generating material supplied from the cartridge 20, and a heating unit 120 for heating the aerosol generating material absorbed into the wick 110 may be arranged on one side of the chamber 14 (e.g., a region in a −y direction).

The wick 110 may be arranged so that at least one area thereof faces an aerosol generating material inlet 11, to absorb the aerosol generating material which flows into the chamber 14 through the aerosol generating material inlet 11.

According to an embodiment, the wick 110 may include a first surface 111 (or an upper end surface) facing the aerosol generating material inlet 11, a second surface 112 (or a lower end surface) opposite to the first surface 111, and a side surface 113 surrounding a space between the first surface 111 and the second surface 112.

The first surface 111 of the wick 110 may be arranged to face the storage tank 21 of the cartridge 20 when the heater module 10 is coupled to the cartridge 20, to absorb the aerosol generating material which flows from the storage tank 21 into the chamber 14 through the aerosol generating material inlet 11.

The second surface 112 of the wick 110 may be located opposite to the first surface 111 and may be arranged to face a bottom surface 14b of the chamber 14. According to an embodiment, the second surface 112 of the wick 110 may be spaced apart from the bottom surface 14b of the chamber 14 by a certain distance.

Otherwise, if the second surface 112 of the wick 110 contacts the bottom surface 14b of the chamber 14, at least a portion of the aerosol generating material absorbed into the wick 110 may leak into an inner space of the heater module 10 or into the aerosol generating device main body 30 along the bottom surface 14b of the chamber 14. As a result, the components of the heater module 10 or a main body may malfunction or be damaged due to the leakage of the aerosol generating material.

In this regard, the heater module 10 according to an embodiment may prevent the aerosol generating material from leaking to the outside of the chamber 14 via a structure in which the second surface 112 of the wick 10 is spaced apart from the bottom surface 14 of the chamber 14.

The side surface 113 of the wick 110 may be arranged to surround the space between the first surface 111 and the second surface 112, and the heater 100 may be arranged in at least one area of the side surface 113 of the wick 110.

The heating unit 120 may be electrically connected to the battery, which is arranged inside the aerosol generating device main body 30, through the heater terminal 300 while the heater module 10 is coupled to the aerosol generating device main body 30. For example, one side of the heater terminal 300 may contact one area of the heating unit 120, and the other side of the heater terminal 300 may contact at least one area of the aerosol generating device main body 30 inserted into an insertion groove 10h, and thus, the heating unit 120 may be electrically connected to the aerosol generating device main body 30. The battery, which is arranged inside the aerosol generating device main body 30, may supply power to the heating unit 120 by an electrical connection described above, and the heating unit 120 may generate heat when power is supplied from the battery thereto, to heat the aerosol generating material absorbed into the wick 110.

The heating unit 120 may be arranged on the side surface 113 of the wick 110, and thus, vapor, which is generated when the aerosol generating material is heated, may be generated in one area of the chamber 14 adjacent to the side surface of 113 of the wick 110. The generated vapor may be mixed with external air introduced into the chamber 14 along the air flow passage 15 extending along an edge of the heater module 10. As a result, an aerosol may be generated in one area of the chamber 14 adjacent to the side surface 113 of the wick 110.

At least a portion of the aerosol, which is generated inside the chamber 14, may be cooled and liquefied by contact with the external air introduced into the chamber 14 through the air flow passage 15, and the liquefied aerosol (or droplets) may fall onto the bottom surface 14b of the chamber 14 and be accumulated or stacked on the bottom surface 14b of the chamber 14.

At least a portion of the wick 110 adjacent to the bottom surface 14b of the chamber 14 may absorb the liquefied aerosol accumulated on the bottom surface 14b and thus prevent the liquefied aerosol from being accumulated inside the chamber 14.

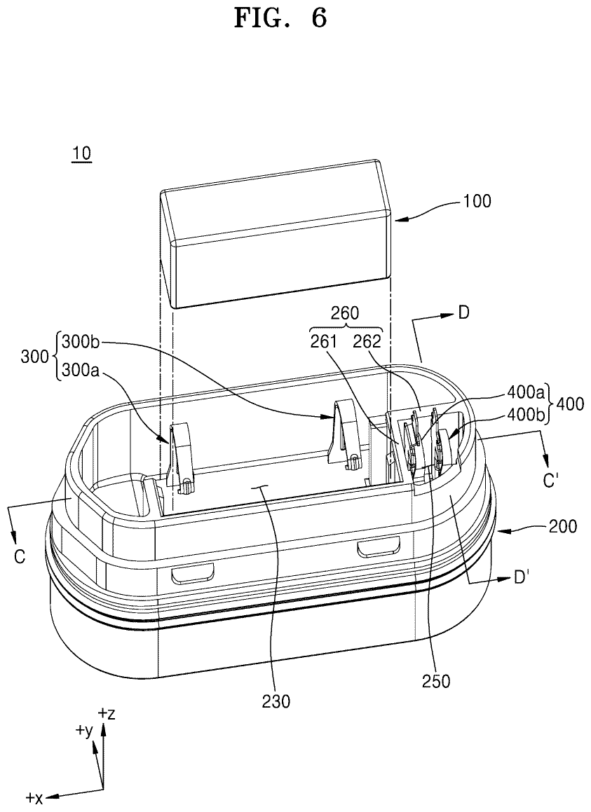

FIG. 6 is a view illustrating a heater module for an aerosol generating device according to an embodiment, which is viewed from the top before a heater 100 is assembled into a module main body 200. Hereinafter, a coupling structure between a heater 100 and a module main body 200 is described with reference to FIG. 6.

Referring to FIG. 6, a heater module 10 according to an embodiment may include the heater 100, the module main body 200, a heater terminal 300, and a recognition terminal 400. The heater module 10 according to an embodiment illustrated in FIG. 6 may be substantially the same as or similar to the heater module 10 illustrated in FIG. 4, and the same description is omitted below.

The module main body 200 may include a heater accommodation groove 230, a recognition terminal accommodation portion 250, and a waterproof partition wall 260.

The heater 100 may be accommodated in the heater accommodation groove 230. The heater accommodation groove 230 may be part of the chamber 14, and may be a space formed on one side of the chamber 14 (e.g., a region in a −y direction). As an example, when the heater 100 is accommodated in the heater accommodation groove 230, the heater 100 may be coupled to the module main body 200 and electrically connected to the heater terminal 300. In other words, the heater terminal 300 may be arranged in the heater accommodation groove 230 within the chamber 14, and thus, the heater 100 may be electrically connected to the heater terminal 300. As another example, when the heater 100 is decoupled from the heater accommodation groove 230, the heater 100 may be decoupled from the module main body 200, and thus, the electrical connection of the heater 100 with the heater terminal 300 may be released.

The heater accommodation groove 230 may be formed in one side of the module main body 200. For example, the heater accommodation groove 230 may be a portion of a space formed inside the first module main body 210 and above the second module main body 220 (e.g., in a +z direction from the second module main body 220).

The recognition terminal 400 may be accommodated in the recognition terminal accommodation portion 250. The recognition terminal accommodation portion 250 may be formed in the module main body 200 at a location spatially apart from the heater accommodation groove 230. The recognition terminal accommodation portion 250 may be a space formed inside the first module main body 210, separated from the heater accommodation groove 230 by the waterproof partition wall 260, and arranged in an upper portion (e.g., a portion facing the +z direction) and a lower portion (e.g., a portion facing a −z direction) of the second module body 220.

According to an embodiment, the waterproof partition wall 260 may perform a function of spatially separating the chamber 14 from the recognition terminal accommodation portion 250. The waterproof partition wall 260 may be located between the chamber 14 and the recognition terminal accommodation 250 to prevent aerosol droplets formed inside the chamber 14 from penetrating into the recognition terminal accommodation portion 250. Accordingly, the waterproof partition wall 260 may prevent the recognition terminal 400 from being broken or damaged by the aerosol droplets flowing into the recognition terminal accommodation portion 250.

In an embodiment, the waterproof partition wall 260 may perform a function of supporting the heater 100 arranged inside the chamber 14. Here, the waterproof partition wall 260 may serve as a support member described above.

The waterproof partition wall 260 may be formed to extend into the first module main body 210 and to the upper portion of the second module main body 220 (e.g., an end portion in the +z direction). The waterproof partition wall 260 may be integrally formed with the module main body 200.

The waterproof partition wall 260 may include a first waterproof partition wall 261 and a second waterproof partition wall 262.

The first waterproof partition wall 261 may extend from an inner surface of the module main body 200. The first waterproof partition wall 261 may be located on one side of the recognition terminal accommodation portion 250 (e.g., a side facing the +x direction). The first waterproof partition wall 261 may prevent the aerosol droplets formed inside the chamber 14 from penetrating into the recognition terminal accommodation portion 250.

The second waterproof partition wall 262 may extend from the inner surface of the module main body 200 and may be connected to the first waterproof partition wall 261. The second waterproof partition wall 262 may be located on another side of the recognition terminal accommodation portion 250 (e.g., a side facing a +y direction).

The second waterproof partition wall 262 may prevent the aerosol droplets formed inside the chamber 14 from penetrating into the recognition terminal accommodation portion 250. The second waterproof partition wall 262 may be integrally formed with the first waterproof partition wall 261.

The heater terminal 300 may be in contact with the heater 100 accommodated in the heater accommodation groove 230. One side of the heater terminal 300 may be arranged on one side of the heater 100 (e.g., a side facing the +y direction) inside the chamber 14 and may be in contact with the heating unit 120 of the heater 100 accommodated in the heater accommodation groove 230.

The heater terminal 300 may be insert-injected or insert molded into the module body 200. That is, according to an embodiment, the module main body 200 and the heater terminal 300 may be manufactured together via a simple manufacturing method such as insert injection. Accordingly, productivity of the heater module 10 may be improved.

According to the heater module 10 according to an embodiment, the heater terminal 300 may include a first heater terminal 300a and a second heater terminal 300b. The first heater terminal 300a and the second heater terminal 300b may be different from each other only with respect to locations on the module main body 200 and may have the same function and structure, and thus, a description is given below on the basis of one heater terminal.

The recognition terminal 400 may contact the cartridge 20 coupled to the heater module 10 while being accommodated in the recognition terminal accommodation portion 250. In an embodiment, the recognition terminal 400 may be in contact with the second coupling element of the cartridge 20 described above. One side of the recognition terminal 400 may contact the cartridge 20 and may extend upwards from one surface of the second module main body 220 (e.g., a surface facing the +z direction).

The recognition terminal 400 may be insert-injected or insert-molded into the module main body 200. That is, according to an embodiment, the module main body 200 and the recognition terminal 400 may be manufactured together via a simple manufacturing method such as insert injection. Accordingly, productivity of the heater module 10 may be improved.

According to the heater module 10, the recognition terminal 400 may include a first recognition terminal 400a and a second recognition terminal 400b. The first recognition terminal 400a and the second recognition terminal 400b may be different from each other only with respect to locations on the module main body 200 and may have the same function and structure, and thus, a description is given below on the basis of one recognition terminal.

Hereinafter, a structure for preventing, through the waterproof partition wall 260, the aerosol droplets generated in the chamber 14 from penetrating into the recognition terminal accommodation portion 250 is described.

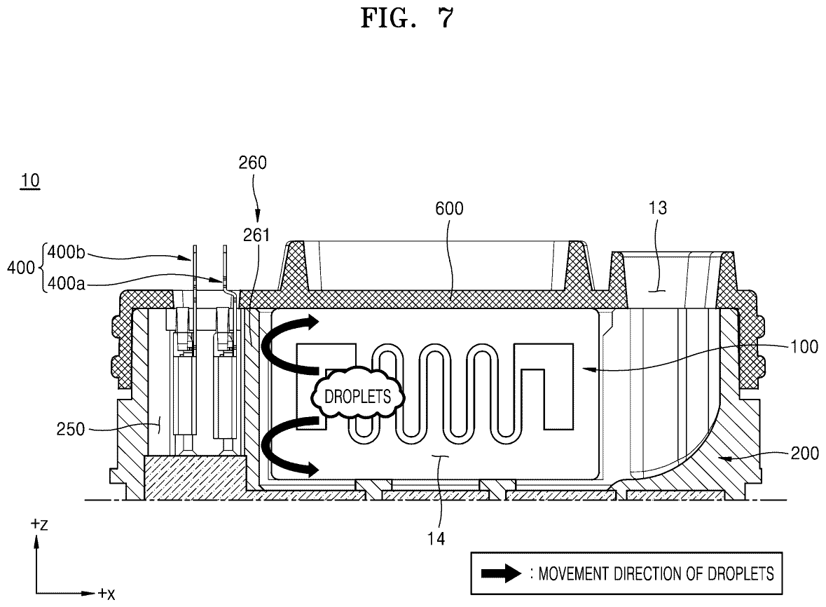

FIG. 7 is a front cross-sectional view of a heater module according to an embodiment, which is taken along line C-C′ of FIG. 6.

Referring to FIG. 7, a heater module 10 according to an embodiment may include an air outlet 13, a chamber 14, a heater 100, a module main body 200, a recognition terminal 400, and an upper cover 600. The heater module 10 according to an embodiment illustrated in FIG. 7 may be substantially the same as or similar to the heater module 10 illustrated in FIG. 6, and the same description is omitted below.

At least a portion of an aerosol, which is generated inside the chamber 14 by the heater 100, may be cooled and liquefied by contact with external air introduced into the chamber 14. As illustrated by an arrow in FIG. 7, aerosol droplets liquefied inside the chamber 14 may flow in the chamber 14.

Here, in a comparative example in which the chamber 14 and a recognition terminal accommodation portion 250 communicate with each other, droplets generated inside the chamber 14 may flow into the recognition terminal accommodation portion 250 and contact the recognition terminal 400 located within the recognition terminal accommodation portion 250. Accordingly, in the comparative example, the recognition terminal 400 may be broken or damaged by the droplets, and thus, a use period of the heater module 10 may be significantly reduced.

However, the heater module 10 according to an embodiment may have a structure in which a first waterproof partition wall 261 of a waterproof partition wall 260 is arranged beside the recognition terminal 400 to spatially separate the chamber 14 from the recognition terminal accommodation portion 250. Accordingly, the droplets generated inside the chamber 14 may not penetrate into the recognition terminal accommodation portion 250, and thus, a possibility that the recognition terminal 400 is broken or damaged by the droplets may be reduced.

In addition, the upper cover 600 may be coupled to an upper portion of the module main body 200 (a portion facing a +z direction), and thus, the heater module 10 may have a structure that may completely seal the chamber 14 and the recognition terminal accommodation portion 250 via the waterproof partition wall 260 and the upper cover 600. Accordingly, a possibility that the droplets generated inside the chamber 14 flow into the recognition terminal accommodation portion 250 may be significantly reduced, and thus, the use period of the heater module 10 according to an embodiment may be increased.

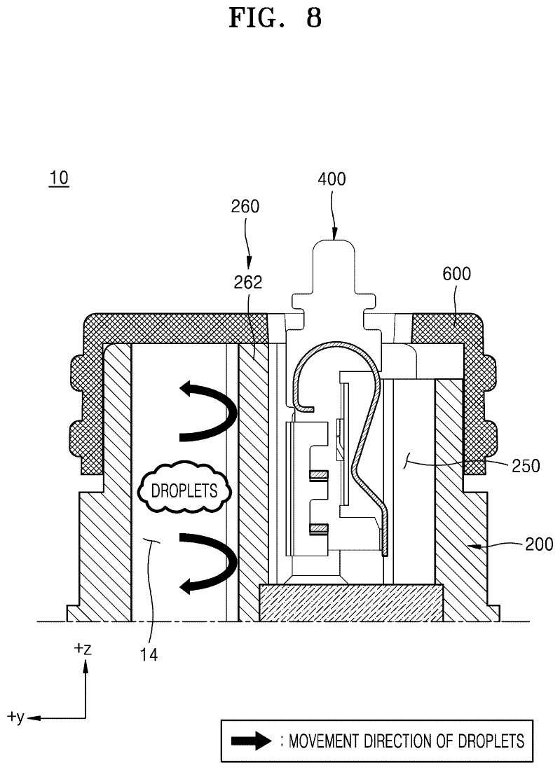

FIG. 8 is a side cross-sectional view of a heater module according to an embodiment, which is taken along line D-D′ of FIG. 6.

Referring to FIG. 8, a heater module 10 may include a module main body 200, a recognition terminal 400, and an upper cover 600. The heater module 10 illustrated in FIG. 8 may be substantially the same as or similar to the heater module 10 illustrated in FIG. 6, and the same description is omitted below.

A chamber 14 of FIG. 8 illustrates one side (e.g., a side facing in a-x direction) of the chamber 14 illustrated in FIG. 7. As illustrated by arrows in FIG. 8, aerosol droplets liquefied inside the chamber 14 may flow in the chamber 14.

Here, in a comparative example in which the chamber 14 and a recognition terminal accommodation portion 250 communicate with each other, droplets generated inside the chamber 14 may flow into the recognition terminal accommodation portion 250 and contact the recognition terminal 400 located within a recognition terminal accommodation portion 250. Accordingly, in the comparative example, the recognition terminal 400 may be broken or damaged by the droplets, and thus, a use period of the heater module 10 may be significantly reduced.

However, the heater module 10 according to an embodiment may have a structure in which a second waterproof partition wall 262 of a waterproof partition 260 is arranged beside the recognition terminal 400 to spatially separate the chamber 14 from the recognition terminal accommodation portion 250. Accordingly, the droplets generated inside the chamber 14 may not penetrate into the recognition terminal accommodation portion 250, and thus, a possibility that the recognition terminal 400 is broken or damaged by the droplets may be reduced.

In addition, the upper cover 600 may be coupled to an upper portion of the module main body 200 (a portion facing a +z direction), and thus, the heater module 10 according to an embodiment may have a structure that may completely seal the chamber 14 and the recognition terminal accommodation portion 250 via the waterproof partition wall 260 and the upper cover 600. Accordingly, a possibility that the droplets generated inside the chamber 14 flow into the recognition terminal accommodation portion 250 may be significantly reduced, and thus, a use period of the heater module 10 for an aerosol generation device according to an embodiment may be increased.

In other words, as described above, the heater module 10 according to an embodiment may be implemented in a structure that surrounds the entire outer side of the recognition terminal accommodation portion 250 through the module main body 200, a first waterproof partition wall 261, the second waterproof partition wall 262, and the upper cover 600. Accordingly, a sealing force for sealing a space of the recognition terminal accommodation portion 250 may be improved, and thus, a possibility that the recognition terminal 400 is damaged by droplets generated inside the chamber 14 may be significantly reduced.

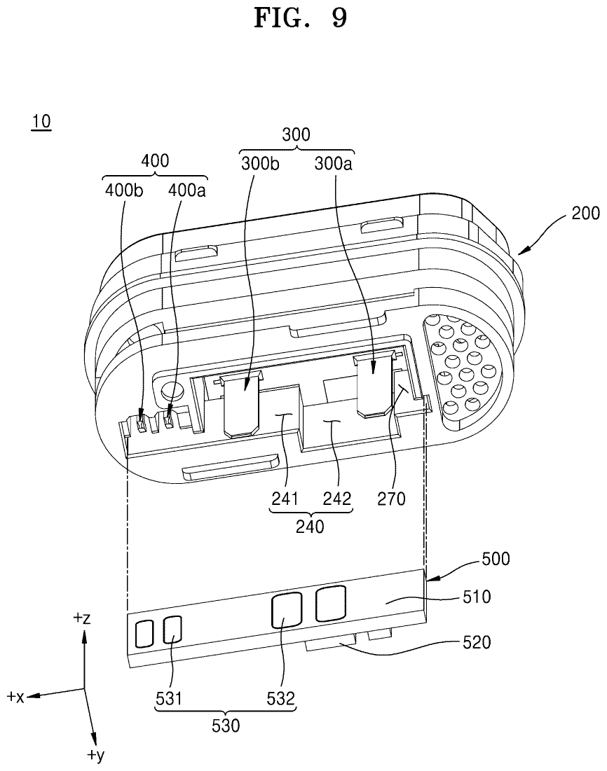

FIG. 9 is a view illustrating a heater module according to an embodiment, which is viewed from the bottom before a PCB unit is assembled into a module main body. Hereinafter, a coupling structure between a module main body 200 and a PCB unit 500 is described with reference to FIG. 9.

Referring to FIG. 9, a heater module 10 may include the module main body 200, a heater terminal 300, a recognition terminal 400, and the PCB unit 500. The heater module 10 illustrated in FIG. 9 may be substantially the same as or similar to the heater module 10 illustrated in FIG. 6, and the same description is omitted below.

A PCB accommodation groove 240 and a connection groove 270 may be formed in the module main body 200.

The PCB unit 500 may be inserted into the PCB accommodation groove 240. As an example, when the PCB unit 500 is inserted into the PCB accommodation groove 240, the recognition terminal 400 may be electrically connected to the PCB unit 500. In other words, a side of the recognition terminal 400 may be arranged on the PCB accommodation groove 240, and thus, the recognition terminal 400 may be electrically connected to the PCB unit 500. Here, the heater terminal 300 may be spaced apart from the PCB unit 500 without contacting the PCB unit 500. Also, when the PCB unit 500 is detached from the PCB accommodation groove 240, the PCB unit 500 may be detached from the module main body 200, and thus, the electrical connection between the PCB unit 500 and the recognition terminal 400 may be released.

The PCB accommodation groove 240 may be formed in a side of the module main body 200. For example, the PCB accommodation groove 240 may be a portion of a space formed inside the first module main body 210 and in a lower portion of the second module main body 220 (e.g., a portion in the −z direction). The PCB accommodation groove 240 may be located under the heater accommodation groove 230 (e.g., in the-z direction from the heater accommodation groove 230). The PCB accommodation groove 240 may communicate with a connection groove 270 and the insertion groove 10h.

The PCB accommodation groove 240 may include a first PCB accommodation groove 241 and a second PCB accommodation groove 242.

A PCB substrate 510 of the PCB unit 500 may be inserted into the first PCB accommodation groove 241. The heater terminal 300 and the recognition terminal 400 may be arranged on one side of the first PCB accommodation groove 241 (e.g., a side in a −y direction), and the second PCB accommodation groove 242 may be arranged on the other side of the first PCB accommodation groove 241 (e.g., a side in a +y direction). The first PCB accommodation groove 241 may communicate with the second PCB accommodation groove 242 and the connection groove 270. The PCB substrate 510 accommodated in the first PCB accommodation groove 241 is described below.

A memory chip 520 of the PCB unit 500 may be inserted into the second PCB accommodation groove 242. The second PCB accommodation groove 242 may have a smaller size than the first PCB accommodation groove 241. The memory chip 520 accommodated in the second PCB accommodation groove 242 is described below.

The connection groove 270 may be located above the insertion groove 10h (e.g., in a +z direction from the insertion groove 10h), and may communicate with the insertion groove 10h and the PCB accommodation groove 240. A side of the heater terminal 300 may be arranged in the connection groove 270, and although not illustrated, at least a portion of the aerosol generating device main body 30 may be inserted into the connection groove 270. As an example, a connection contact (not shown) described above may be arranged in the connection groove 270.

The PCB unit 500 may include the PCB substrate 510, the memory chip 520, and a PCB contact portion 530.

The recognition terminal 400 may be in contact with the PCB substrate 510. The PCB substrate 510 may support the memory chip 520 and the PCB contact portion 530, and may be accommodated in the first PCB accommodation groove 241. As such, the PCB substrate 510 may be connected to the recognition terminal 400 and the aerosol generating device main body 30 such that the cartridge 20 and the aerosol generating device main body 30 are electrically connected.

The memory chip 520 may be arranged on the PCB substrate 510. As an example, the memory chip 520 may be arranged on one side of the PCB substrate 510 (e.g., a side facing the +y direction). The memory chip 520 may be hardware that stores various types of data processed within the aerosol generating device 1, and may store pieces of data processed by a controller and pieces of data to be processed by the controller. The memory chip 520 may include at least one type of storage medium from among a flash memory type, a hard disk type, a multimedia card micro type, a card type memory (e.g., SD or XD memory or the like), random access memory (RAM), static random access memory (SRAM), read-only memory (ROM), electrically erasable programmable read-only memory (EEPROM), programmable read-only memory (PROM), magnetic memory, magnetic disk, and optical disk. The memory chip 520 may store data regarding an operation time of the aerosol generating device 1, the maximum number of puffs, the current number of puffs, at least one temperature profile, and a smoking pattern of the user, and the like.

According to an embodiment, the memory chip 520 may determine a preset remaining amount of use of a heater by counting the number of puffs by the user. For example, when a service life set in the heater 100 is 500 puffs, the memory chip 520 may determine a remaining amount of use of the heater 100 by counting the number of puffs by the user and display the remaining amount of use of the heater 100 on a display of the aerosol generating device 1.

The PCB contact portion 530 may be a terminal for an electrical connection between the recognition terminal 400 and the aerosol generating device main body 30, and may be arranged on the PCB substrate 510. The PCB contact portion 530 may be arranged on a side of the PCB substrate 510 (e.g., a side facing the −y direction).

In an embodiment, the PCB contact portion 530 may be a conductive pattern printed on the PCB substrate 510. For example, the PCB contact portion 530 may be formed by printing a metal material (e.g., stainless steel) on a side of the PCB substrate 510 (e.g., a side facing the −y direction), but is not limited thereto.

The PCB contact portion 530 may include a first PCB contact portion 531 with which the recognition terminal 400 is in contact, and a second PCB contact portion 532 with which the connection contact (not shown) of the aerosol generating device 1 is in contact. When the recognition terminal 400 contacts the first PCB contact portion 531, the cartridge 20 and the PCB unit 500 may be electrically connected to each other. Also, when the second PCB contact portion 532 contacts the connection contact (not shown), the PCB unit 500 and the aerosol generating device main body 30 may be electrically connected to each other.

The PCB contact portion 530 may include the same number of first PCB contact portions 531 as the recognition terminals 400, and the same number of second PCB contact portions 532 as the connection contacts (not shown). Although FIG. 9 illustrates two first PCB contact portions 531 and two second PCB contact portions 532, the numbers of the first PCB contact portions 531 and the second PCB contact portions 532 are not limited thereto.

Hereinafter, a structure of the heater terminal 300 according to an embodiment is described in detail with reference to the accompanying drawings.

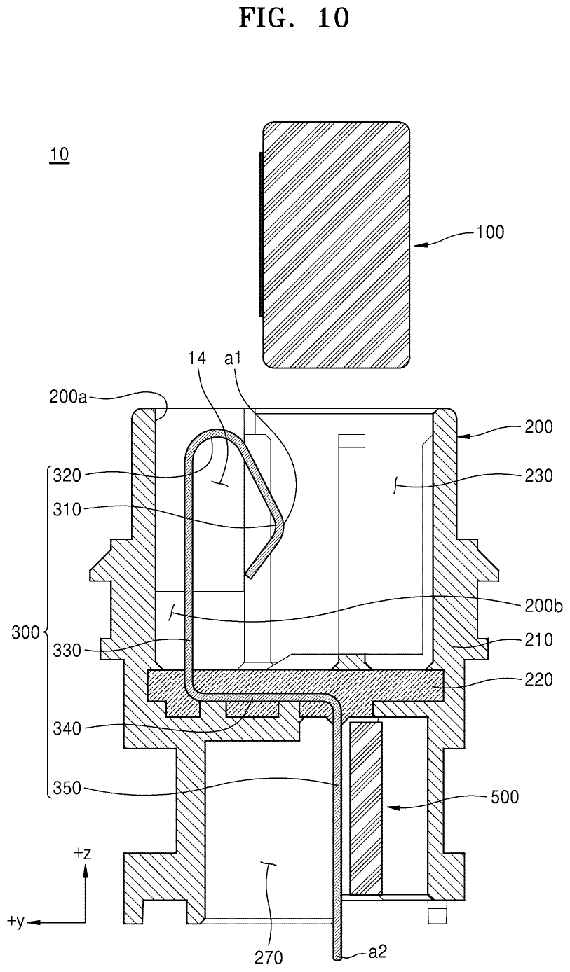

FIG. 10 is a schematic side cross-sectional view of a heater module according to an embodiment.

Referring to FIG. 10, a heater module 10 according to an embodiment may include a heater 100, a module main body 200, a heater terminal 300, and a PCB unit 500. The heater module 10 according to an embodiment illustrated in FIG. 10 may be substantially the same as or similar to the heater module 10 illustrated in FIG. 6, and the same description is omitted below.

The heater terminal 300 may include a first heater terminal element 310, a second heater terminal element 320, and a third heater terminal element 330.

The first heater terminal element 310 may be in contact with the heater 100 accommodated in a heater accommodation groove 230. Accordingly, a protruding portion a1 of the first heater terminal element 310 may protrude toward the heater accommodation groove 230. The first heater terminal element 310 may be in contact with the heating unit 120 of the heater 100 accommodated in the heater accommodation groove 230.

According to an embodiment, at least a portion of the first heater terminal element 310 may include a curved surface. Accordingly, even when the heating unit 120 of the heater 100 is in contact with the first heater terminal element 310 while the heater 100 is being inserted into the heater accommodation groove 230, the heater 100 may be smoothly inserted into the heater accommodation groove 230 without being damaged.

According to an embodiment, the first heater terminal element 310 may be connected to the second heater terminal element 320 to elastically move. Accordingly, when the heater 100 is inserted into the heater accommodation groove 230, the first heater terminal element 310 may be pushed in a direction (e.g., in a +y direction) toward an inner surface 200a of the module main body 200 so that the heater 100 may be easily inserted into the heater accommodation groove 230.

The second heater terminal element 320 may be connected to the first heater terminal element 310. The second heater terminal element 320 may be connected to each of the first heater terminal element 310 and the third heater terminal element 330, and may be located in the chamber 14 that is an inside of the module main body 200. The second heater terminal element 320 may be formed in an overall inverted “U” shape, but may also be formed in any different shape that may be connected to the first heater terminal element 310.

According to an embodiment, at least a portion of the second heater terminal element 320 may include a curved surface. Accordingly, even when the heating unit 120 of the heater 100 is in contact with the second heater terminal element 320 while the heater 100 is being inserted into the heater accommodation groove 230, the heater 100 may be smoothly inserted into the heater accommodation groove 230 without being damaged.

According to an embodiment, a portion of the second heater terminal element 320 facing the heater accommodation groove 230 may be formed to be inclined. In other words, the second heater terminal element 320 may include an inclined portion that is inclined with respect to a direction (i.e., the extending direction of the third heater terminal element 330—the z-axis direction in FIG. 10) in which the heater 100 is inserted into the heater accommodation groove 230. Accordingly, even when the heater 100 is pushed toward a location deviated from the heater accommodation groove 230 (e.g., a location deviated from the heater accommodation groove 230 in the +y direction), the heater 100 may be guided toward the heater accommodation groove 230 along the inclined surface of the second heater terminal element 320. Accordingly, the heater module 10 for an aerosol generating apparatus according to an embodiment may improve ease of assembly of the heater 100 and the module main body 200.

The third heater terminal element 330 may be connected to the second heater terminal element 320 and coupled to the second module main body 220. As an example, one side of the third heater terminal element 330 may be connected to the second heater terminal element 320, and the other side of the third heater terminal element 330 may be connected to a fourth heater terminal element 340 while being coupled to the second module main body 220. Since the third heater terminal element 330 is coupled to the second module main body 220, the first heater terminal element 310 and the second heater terminal element 320 may be supported by the third heater terminal element 330.

The third heater terminal element 330 may be coupled to the second module main body 220, and may extend upwards (e.g., in the +z direction) from an upper surface of the second module main body 220 while being spaced apart from an inner surface 200a of the module main body 200. As such, a separation space 200b may be formed between the third heater terminal element 330 and the inner surface 200a of the module main body 200. The separation space 200b may be a space included in the chamber 14.

According to an embodiment, the third heater terminal element 330 may be coupled to the second module main body 220 to elastically move. Accordingly, when the heater 100 is inserted into the heater accommodation groove 230, the third heater terminal element 330 may be pushed into the separation space 200b together with the first heater terminal element 310 and the second heater terminal element 320, so that the heater 100 may be easily inserted into the heater accommodation groove 230.

Referring to FIG. 10, the heater terminal 300 may further include the fourth heater terminal element 340 and a fifth heater terminal element 350.

The fourth heater terminal element 340 may be connected to the third heater terminal element 330. The fourth heater terminal element 340 may be arranged in the second module main body 220 while being connected to each of the third heater terminal element 330 and the fifth heater terminal element 350.

The fourth heater terminal element 340 may extend in a direction (e.g., in a y-axis direction) crossing a direction in which the third heater terminal element 330 extends. As an example, the fourth heater terminal element 340 may extend in a direction perpendicular to the direction in which the third heater terminal element 330 extends, and may extend in a direction parallel to a direction in which the second module main body 220 extends. Accordingly, an empty space (e.g., a connection groove 270) may be formed under (e.g., in a −z direction from the fourth heater terminal element 340), and one component of the aerosol generating device main body 30 (e.g., a connection contact) may be arranged in the empty space. Therefore, the heater module 10 according to an embodiment may have a structure in which the module main body 200 has a space for arranging the aerosol generating device main body 30.

The fifth heater terminal element 350 may be connected to the fourth heater terminal element 340 and coupled to the second module main body 220. As an example, one side of the fifth heater terminal element 350 may be connected to the fourth heater terminal element 340 while being arranged in the second module main body 220, and the other side of the fifth heater terminal element 350 may be arranged in the connection groove 270.

The fifth heater terminal element 350 may be coupled to the second module main body 220 while being spaced apart from the PCB unit 500, and may extend downwards (e.g., in the −z direction) from a lower surface of the second module main body 220.

In an embodiment, the first heater terminal element 310, the second heater terminal element 320, the third heater terminal element 330, the fourth heater terminal element 340, and the fifth heater terminal element 350 may be integrally formed.

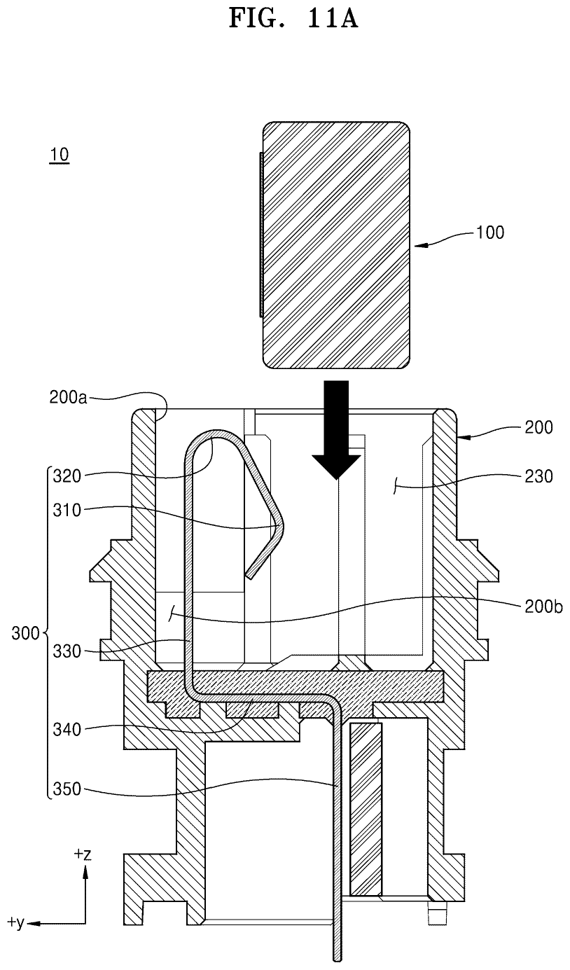

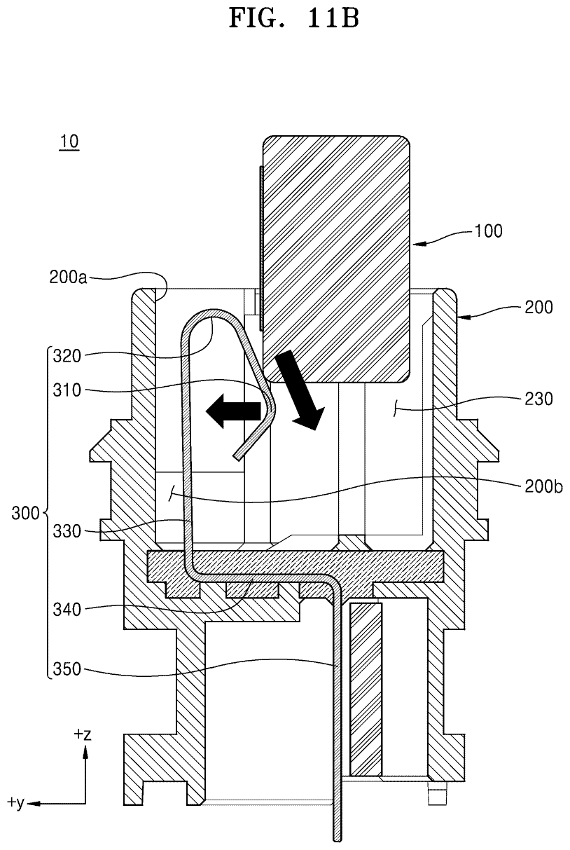

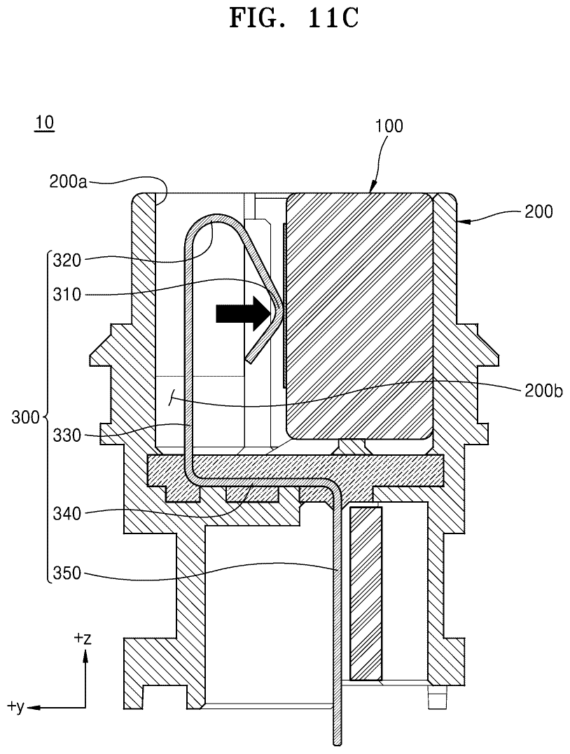

FIGS. 11A to 11C are views illustrating a process in which a heater is inserted into a heater accommodation groove, according to an embodiment. A heater module 10 illustrated in FIGS. 11A to 11C may be substantially the same as or similar to the heater module 10 illustrated in FIG. 10, and the same description is omitted below.

Referring to FIG. 11A, the heater 100 is not coupled to a module main body 200, and starts to move towards the module main body 200 for coupling. Here, due to carelessness of an assembler who assembles the heater module 10 or a failure of an assembly process unit, the heater 100 may be pushed toward a location deviated from a heater accommodation groove 230 in the direction of a heater terminal 300 (e.g., in a +y direction).

Referring to FIG. 11B, the heater 100 may start to be inserted into the heater accommodation groove 230. Here, a portion of at least one of a first heater terminal element 310 and the second heater terminal element 320 may include a curved surface, and thus, the heater 100 may be smoothly inserted into the heater accommodation groove 230 without being damaged even when the heating unit 120 of the heater 100 is in contact with the heater terminal 300.

In addition, when the heater 100 is inserted into the heater accommodation groove 230, the first, second, and third heater terminal elements 310, 320, and 330 may be pushed together into a separation space 200b, so that the heater 100 may be easily inserted into the heater accommodation groove 230. In other words, the first heater terminal element 310 may be connected to the second heater terminal element 320 to elastically move, and the third heater terminal element 330 may be coupled to the second module main body 220 to elastically move, and thus, the heater 100 may be smoothly inserted into the heater accommodation groove 230.

In addition, even when the heater 100 is pushed toward a location deviated from the heater accommodation groove 230 in the direction of the heater terminal 300 (e.g., in the +y direction), the heater 100 may be guided toward the heater accommodation groove 230 (e.g., in a-y direction) along an inclined surface of the second heater terminal element 320. In other words, the second heater terminal element 320 may include the inclined surface that is inclined with respect to a direction in which the heater 100 is inserted into the heater accommodation groove 230, and thus, the heater 100 may be easily inserted into the heater accommodation groove 230.

As described above, the heater terminal 300 may have a structure that facilitates insertion of the heater 100 into the heater accommodation groove 230 and prevents the heating unit 120 of the heater 100 from being damaged when the heater 100 is inserted into the heater accommodation groove 230. Accordingly, the heater module 10 according to an embodiment may improve ease of assembly between the heater 100 and the module main body 200.

Referring to FIG. 11C, the heater 100 is completely inserted into the heater accommodation groove 230. The first, second, and third heater terminal elements 310, 320, and 330, which have moved in one direction (e.g., in the +y direction) while the heater 100 is inserted into the heater accommodation groove 230, may contact the heating unit 120 of the heater 100 to pressurize the heating unit 120 in the opposite direction (e.g., in the −y direction). Here, the first, second, and third heater terminal elements 310, 320, and 330 may pressurize the heating unit 120 of the heater 100 with a restoring force due to an elastic force, and thus, contact reliability between the heating unit 120 and the heater terminal 300 may be improved.

Hereinafter, another structure of the heater terminal 300 is described in detail with reference to the accompanying drawings.

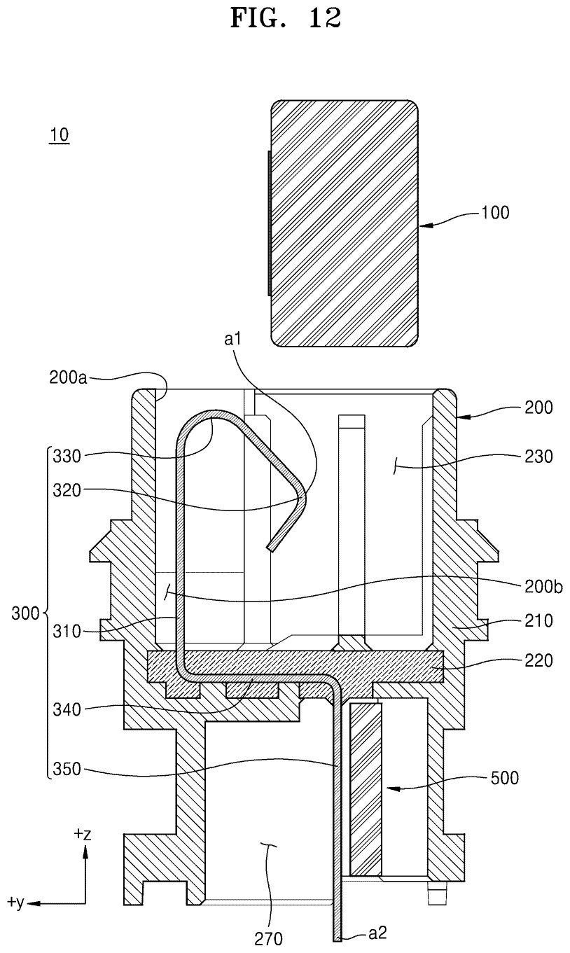

FIG. 12 is a schematic side cross-sectional view of a heater module according to another embodiment.

Referring to FIG. 12, a heater module 10 according to an embodiment may include a heater 100, a module main body 200, a heater terminal 300, and a PCB unit 500. The heater module 10 according to an embodiment illustrated in FIG. 12 may be substantially the same as or similar to the heater module 10 illustrated in FIG. 10, the same description is omitted below, and differences are mainly described.

According to the present embodiment, a first heater terminal element 310 may protrude further toward a heater accommodation groove 230 than in the embodiment illustrated in FIG. 10.

In the embodiment illustrated in FIG. 12, a protruding portion al of the first heater terminal element 310 may be located within the heater accommodation groove 230. In an embodiment, the protruding portion a1 of the first heater terminal element 310 may be located between one side of the heater accommodation groove 230 (e.g., a side in a +y direction) and a middle portion of the heater accommodation groove 230, while the heater 100 is not accommodated in the heater accommodation groove 230. In an embodiment, the protruding portion a1 of the first heater terminal element 310 may be located at the middle portion of the heater accommodation groove 230 while the heater 100 is not accommodated in the heater accommodation groove 230.

In the embodiment shown in FIG. 12, the protruding portion al of the first heater terminal element 310 may be spaced apart from the inner surface 200a of the module main body 200 in the direction of the heater accommodation groove 230.

In the embodiment illustrated in FIG. 12, a separation distance between the protruding portion a1 of the first heater terminal element 310 and an inner surface 200a of the module main body 200 may be greater than in the embodiment illustrated in FIG. 10. In other words, a separation distance between the protruding portion a1 of the first heater terminal element 310 and a third heater terminal element 330 may be greater than in the embodiment illustrated in FIG. 10.

In the embodiment illustrated in FIG. 12, an included angle between the first heater terminal element 310 and the third heater terminal element 330 may be greater than an included angle between the first heater terminal element 310 and the third heater terminal element 330 in the embodiment illustrated in FIG. 10. For example, in the embodiment illustrated in FIG. 12, the included angle between the first heater terminal element 310 and the third heater terminal element 330 may be 60 degrees or more.

Accordingly, compared to the embodiment shown in FIG. 10, in the heater module 10 according to the embodiment shown in FIG. 12, the first heater terminal element 310 may further protrude toward the heater accommodation groove 230, and thus may pressurize the heater 100 accommodated in the heater accommodation groove 230 with a greater force. Accordingly, contact reliability between the heating unit 120 of the heater 100 and the first heater terminal element 310 may be further improved.

In addition, compared to the embodiment shown in FIG. 10, the protruding portion a1 of the first heater terminal element 310 may be arranged closer to the heater accommodation groove 230, and thus, a distance between the protruding portion al of the first heater terminal element 310 and an end portion a2 of a fifth heater terminal element 350 arranged under the heater accommodation groove 230 (e.g., in a-z direction from the heater accommodation groove 23) may be reduced. The heating unit 120 may be in contact with the protruding portion al of the first heater terminal element 310, and the battery of the aerosol generating device 1 may be connected to the end portion a2 of the fifth heater terminal element 350.

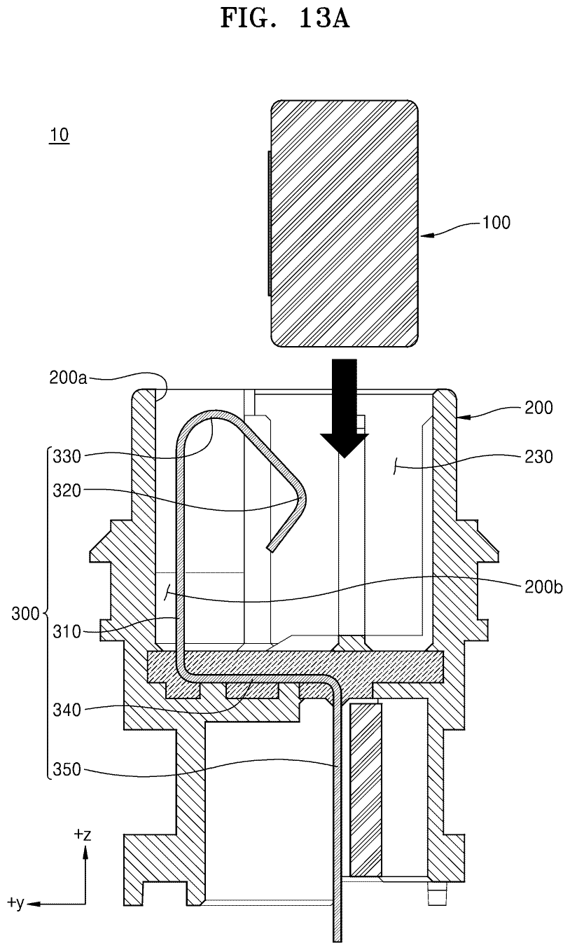

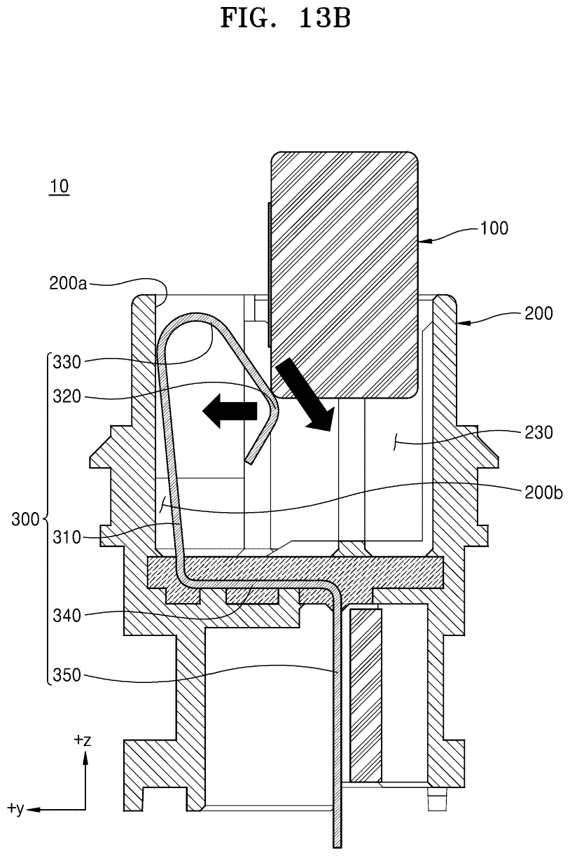

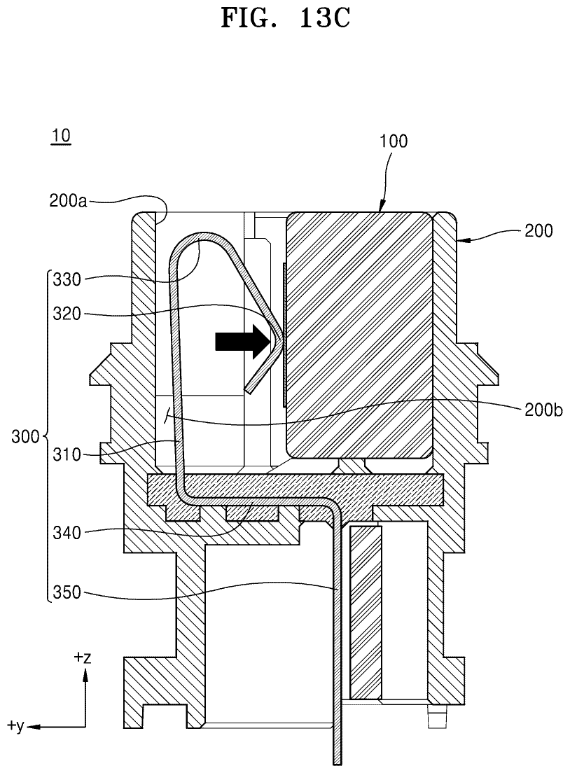

FIGS. 13A to 13C are views illustrating a process in which a heater is inserted into a heater accommodation groove, according to another embodiment. Hereinafter, a process in which a heater 100 is inserted into a heater accommodation groove 230 is described with reference to the accompanying drawings. A heater module 10 according to an embodiment illustrated in FIGS. 13A to 13C may be substantially the same as or similar to the heater module 10 illustrated in FIG. 12, and the same description is omitted below.

Referring to FIG. 13A, a heater 100 starts to move to a module main body 200 while the heater 100 is detached from the module main body 200. Here, due to carelessness of an assembler who assembles the heater module 10 or a failure of an assembly process unit, the heater 100 may be pushed toward a location deviated from the heater accommodation groove 230 in the direction of a heater terminal 300 (e.g., in a +y direction).

Referring to FIG. 13B, the heater 100 may start to be inserted into the heater accommodation groove 230. Here, a portion of at least one of a first heater terminal element 310 and the second heater terminal element 320 may include a curved surface, and thus, the heater 100 may be smoothly inserted into the heater accommodation groove 230 without being damaged even when the heating unit 120 of the heater 100 is in contact with a heater terminal 300.

In addition, when the heater 100 is inserted into the heater accommodation groove 230, the first, second, and third heater terminal elements 310, 320, and 330 may be pushed together into a separation space 200b, so that the heater 100 may be easily inserted into the heater accommodation groove 230. In other words, the first heater terminal element 310 may be connected to the second heater terminal element 320 to elastically move, and the third heater terminal element 330 may be coupled to the second module main body 220 to elastically move, and thus, the heater 100 may be smoothly inserted into the heater accommodation groove 230.

Here, compared to the embodiment illustrated in FIG. 10, since the first heater terminal element 310 may protrude further toward the heater accommodation groove 230, the first, second, and third heater terminal elements 310, 320, and 330 may contact an inner surface 200a of a module main body 200 while being pushed together toward the separation space 200b.

In addition, even when the heater 100 is pushed toward a location deviated from the heater accommodation groove 230 in the direction of the heater terminal 300 (e.g., in a +y direction), the heater 100 may be guided toward the heater accommodation groove 230 (e.g., in a −y direction) along an inclined surface of the second heater terminal element 320. In other words, the second heater terminal element 320 may include the inclined surface that is inclined with respect to a direction in which the heater 100 is inserted into the heater accommodation groove 230, and thus, the heater 100 may be easily inserted into the heater accommodation groove 230.

As described above, the heater terminal 300 may have a structure that facilitates insertion of the heater 100 into the heater accommodation groove 230 and prevents the heating unit 120 of the heater 100 from being damaged when the heater 100 is inserted into the heater accommodation groove 230. Accordingly, the heater module 10 according to an embodiment may improve ease of assembly between the heater 100 and the module main body 200.

Referring to FIG. 13C, the heater 100 is completely inserted into the heater accommodation groove 230. The first, second, and third heater terminal elements 310, 320, and 330, which have moved in one direction (e.g., in a +y direction) while the heater 100 is inserted into the heater accommodation groove 230, may contact the heating unit 120 of the heater 100 to pressurize the heating unit 120 in the opposite direction (e.g., in a −y direction). Here, the first, second, and third heater terminal elements 310, 320, and 330 may pressurize the heating unit 120 of the heater 100 with a restoring force due to an elastic force, and thus, contact reliability between the heating unit 120 and the heater terminal 300 may be improved.

Compared to the embodiment illustrated in FIG. 10, according to the heater module 10 according to the embodiment of FIG. 13C, the first heater terminal element 310 may further protrude toward the heater accommodation groove 230, and thus, the first, second, and third heater terminal elements 310, 320, and 330 may contact the inner surface 200a of the module body 200 while being pushed together toward the separation space 200b. That is, the first, second, and third heater terminal elements 310, 320, and 330 may contact the heating unit 120 of the heater 100 while supported by the inner surface 200a of the module main body 200, and thus may pressurize the heater 100 accommodated in the heater accommodation groove 230 with a greater force.

In addition, compared to the embodiment described in FIG. 10, according to the heater module 10 according to the present embodiment, the first heater terminal element 310 may further protrude toward the heater accommodation groove 230, and thus may pressurize the heating unit 120 of the heater 100 with a restoring force due to a greater elastic force.

Therefore, the heater module 10 according to the present embodiment may further improve contact reliability between the heating unit 120 of the heater 100 and the first heater terminal element 310, compared to the embodiment shown in FIG. 10.

Hereinafter, a structure of the recognition terminal 400 is described in detail with reference to the accompanying drawings.

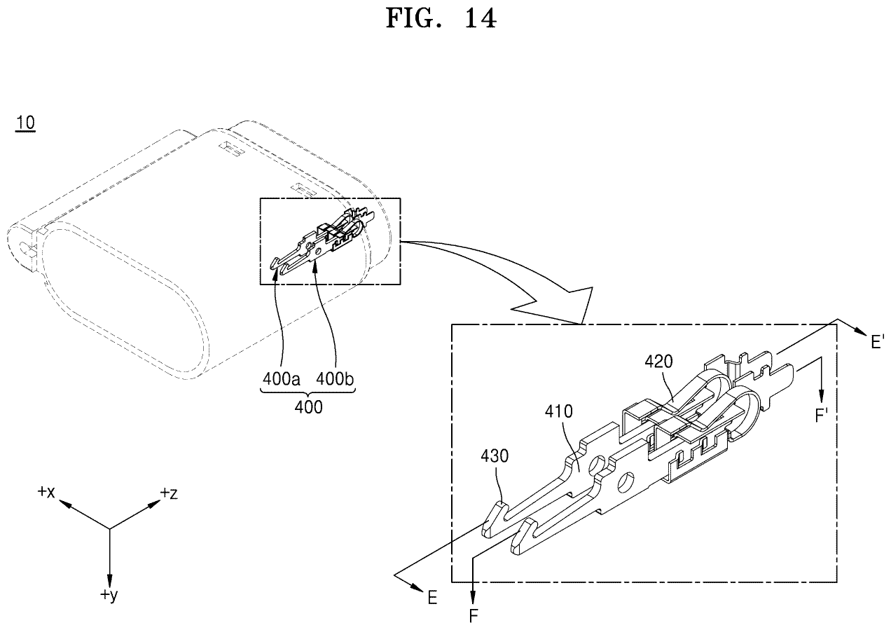

FIG. 14 is a view illustrating a recognition terminal which is arranged inside a heater module, according to an embodiment. The heater module 10 illustrated in FIG. 14 may be substantially the same as or similar to the heater module 10 illustrated in FIG. 6, and the same description is omitted below.

Referring to FIG. 14, a recognition terminal 400 may be located in the recognition terminal accommodation portion 250 inside the heater module 10, and may be electrically connected to the PCB unit 500 and the cartridge 20. The recognition terminal 400 may include a first recognition terminal 400a and a second recognition terminal 400b, and the first recognition terminal 400a and the second recognition terminal 400b may have the same or similar functions and shapes.

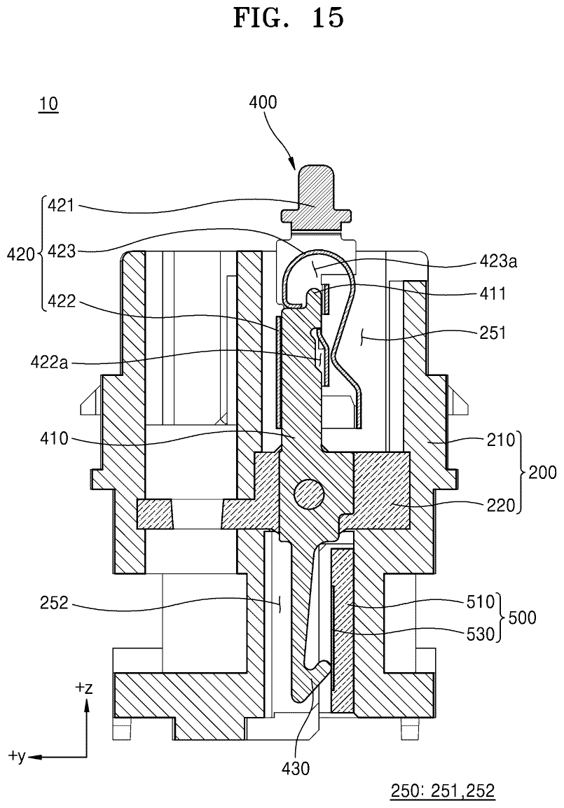

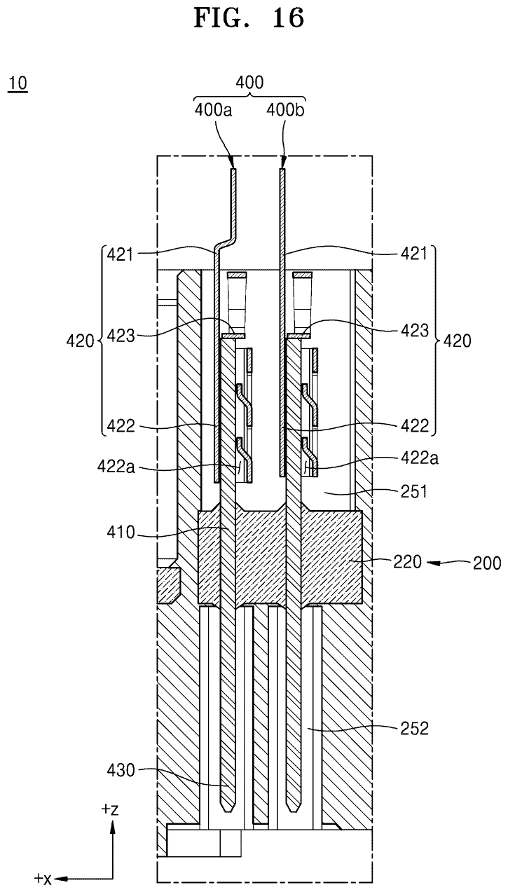

The recognition terminal 400 may include a recognition terminal main body 410, a cartridge contact element 420, and a PCB contact element 430. A detailed structure of the recognition terminal 400 is described below with reference to FIGS. 15 and 16.

FIG. 15 is a schematic side cross-sectional view of a heater module according to an embodiment, which is taken along line E-E′ of FIG. 14.

Referring to FIG. 15, a heater module 10 may include a module main body 200, a recognition terminal 400, and a PCB unit 500. The heater module 10 illustrated in FIG. 15 may be substantially the same as or similar to the heater module 10 illustrated in FIG. 14, and the same description is omitted below.

A recognition terminal accommodation portion 250 formed in the module main body 200 may include a first recognition terminal accommodation portion 251 and a second recognition terminal accommodation portion 252.

At least a portion of the recognition terminal 400 may be accommodated in the first recognition terminal accommodation portion 251. In an example, an upper portion of a recognition terminal main body 410 (e.g., a portion facing a +z direction) and a cartridge contact element 420 may be accommodated in the first recognition terminal accommodation portion 251. The first recognition terminal accommodation portion 251 may be a space formed inside a first module main body 210 and above a second module main body 220 (e.g., in the +z direction).

At least a portion of the recognition terminal 400 may be accommodated in the second recognition terminal accommodation portion 252. In an example, the second recognition terminal accommodation 250 may accommodate a lower portion of the recognition terminal main body 410 and the PCB contact element 430. The second recognition terminal accommodation portion 252 may be a space formed inside the first module main body 210 and under the second module main body 220 (e.g., in a −z direction from the second module main body 220), and may communicate with a PCB accommodation groove 240 in which the PCB unit 500 is accommodated.

The recognition terminal main body 410 may be connected to the cartridge contact element 420 and the PCB contact element 430. One side of the recognition terminal main body 410 may be electrically connected to the cartridge contact element 420 while being accommodated in the first recognition terminal accommodation portion 251, and the other side of the recognition terminal main body 410 may be connected to the PCB contact element 430 while being accommodated in the second recognition terminal accommodation portion 252. In other words, the recognition terminal main body 410 may perform a function of connecting the cartridge contact element 420 connected to the cartridge 20 to the PCB contact element 430 connected to the PCB unit 500.

The recognition terminal main body 410 may pass through the second module main body 220 while being accommodated in the recognition terminal accommodation portion 250. The recognition terminal main body 410 may extend in a direction (e.g., in a z-axis direction) in which the aerosol generating device 1 extends.

The cartridge contact element 420 may be electrically connected to the cartridge 20. The cartridge contact element 420 may be in contact with the cartridge 20 coupled to an upper portion (e.g., an end portion in the +z direction) of the module body 20. One portion of the cartridge contact element 420 may be electrically connected to the cartridge 20 while being located at an upper end portion of the first recognition terminal accommodation portion 251, and another portion of the cartridge contact element 420 may be electrically connected to the recognition terminal main body 410 while being located at a lower end portion of the first recognition terminal accommodation portion 251. In other words, the cartridge contact element 420 may perform a function of connecting the cartridge 20 to the recognition terminal main body 410.

The cartridge contact element 420 may include a cartridge contact portion 421, a terminal accommodation portion 422, and a round portion 423.

The cartridge contact portion 421 may be connected to the cartridge 20. The cartridge contact portion 421 may be electrically connected to the cartridge 20 and the terminal recognition main body 410 while being arranged above the terminal accommodation portion 422 (e.g., in a +z direction from the terminal accommodation portion 422).

The terminal accommodation portion 422 may be arranged to be connected to the cartridge contact portion 421 and to surround at least a portion of the recognition terminal main body 410. The terminal accommodation portion 422 may be arranged to surround at least a portion of the recognition terminal main body 410, and thus, a first contact terminal accommodation portion 422a may be formed inside the terminal accommodation portion 422.

As an example, the terminal accommodation portion 422 may be arranged to surround an upper portion (e.g., a portion facing the +z direction) of the recognition terminal main body 410 accommodated in the first recognition terminal accommodation portion 251. The recognition terminal main body 410 may be connected to the cartridge contact element 420 while being accommodated in the first contact terminal accommodation portion 422a.

The round portion 423 may be connected to the terminal accommodation portion 422. The round portion 423 may be arranged to surround at least a portion of the terminal accommodation portion 422 and at least a portion of the recognition terminal main body 410. The round portion 423 may include a curved surface that is bent toward the cartridge contact portion 421.

The round portion 423 may be arranged to surround at least the portion of the terminal accommodation portion 422 and at least the portion of the recognition terminal main body 410, and thus, a second contact terminal accommodation portion 423a may be formed inside the round portion 423. As an example, while an end portion 411 of the recognition terminal main body 410 is inserted into the second contact terminal accommodation portion 423a, the recognition terminal main body 410 may be connected to the cartridge contact element 420.

In an embodiment, the recognition terminal main body 410, the terminal accommodation portion 422, and the round portion 423 may be integrally formed.

The PCB contact element 430 may be connected to the recognition terminal main body 410. The PCB contact element 430 may be in contact with a PCB contact portion 530 of the PCB unit 500 accommodated in the PCB accommodation groove 240. The PCB contact element 430 may be accommodated in the second recognition terminal accommodation portion 252, and may include a portion protruding toward the PCB contact portion 530. In an example, the PCB contact element 430 may be integrally formed with the recognition terminal main body 410.

FIG. 16 is a schematic front cross-sectional view of a heater module according to an embodiment, which is taken along line F-F′ of FIG. 14.

Referring to FIG. 16, a heater module 10 according to an embodiment may include a module main body 200 and a recognition terminal 400. The heater module 10 according to an embodiment illustrated in FIG. 16 may be substantially the same as or similar to the heater module 10 illustrated in FIG. 15, and the same description is omitted below.

A recognition terminal main body 410 may be connected to a cartridge contact element 420 and a PCB contact element 430. The recognition terminal main body 410 may pass through a second module main body 220 while being accommodated in a recognition terminal accommodation portion 250.

The cartridge contact element 420 may include a cartridge contact portion 421, a terminal accommodation portion 422, and a round portion 423.

The cartridge contact portion 421 may be connected to the cartridge 20. The cartridge contact portion 421 may be electrically connected to the cartridge 20 and the recognition terminal main body 410 while being arranged above the terminal accommodation portion 422 (e.g., in a +z direction from the terminal accommodation portion 422).

In the embodiment illustrated in FIG. 16, a shape of the cartridge contact portion 421 of a first recognition terminal 400a and a shape of the cartridge contact portion 421 of a second recognition terminal 400b are partially different from each other. For example, the cartridge contact portion 421 of the second recognition terminal 400b may extend in one direction (e.g., in a z-axis direction), but the cartridge contact portion 421 of the first recognition terminal 400a may include a portion extending in another direction (e.g., in the x-axis direction) crossing the one direction.

Except for some differences in the shape, the first recognition terminal 400a and the second recognition terminal 400b may be implemented in the same manner.

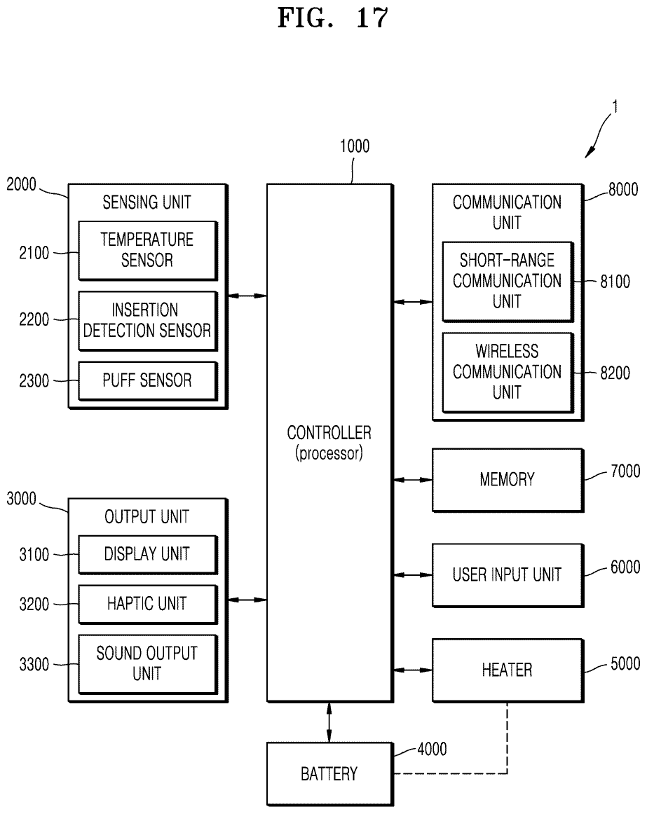

FIG. 17 is a block diagram of an aerosol generating device according to another embodiment.

The aerosol generating device 1 may include a controller 1000, a sensing unit 2000, an output unit 3000, a battery 4000, a heater 5000, a user input unit 6000, a memory 7000, and a communication unit 8000. However, the internal structure of the aerosol generating device 1 is not limited to those illustrated in FIG. 17. In other words, according to the design of the aerosol generating device 1, it will be understood by one of ordinary skill in the art that some of the components shown in FIG. 17 may be omitted or new components may be added.

The sensing unit 2000 may sense a state of the aerosol generating device 1 and a state around the aerosol generating device 1, and transmit sensed information to the controller 1000. Based on the sensed information, the controller 1000 may control the aerosol generating device 1 to perform various functions, such as controlling an operation of the heater 5000, limiting smoking, determining whether an aerosol generating article (e.g., a cigarette, a cartridge, or the like) is inserted, displaying a notification, or the like.

The sensing unit 2000 may include at least one of a temperature sensor 2100, an insertion detection sensor 2200, and a puff sensor 2300, but is not limited thereto.

The temperature sensor 2100 may sense a temperature at which the heater 5000 (or an aerosol generating material) is heated. The aerosol generating device 1 may include a separate temperature sensor for sensing the temperature of the heater 5000, or the heater 5000 may serve as a temperature sensor. Alternatively, the temperature sensor 2100 may also be arranged around the battery 4000 to monitor the temperature of the battery 4000.

The insertion detection sensor 2200 may sense insertion and/or removal of an aerosol generating article. For example, the insertion detection sensor 2200 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 2300 may sense a user's puff on the basis of various physical changes in an airflow passage or an airflow channel. For example, the puff sensor 2300 may sense a user's puff on the basis of any one of a temperature change, a flow change, a voltage change, and a pressure change.

The sensing unit 2000 may include, in addition to the temperature sensor 2100, the insertion detection sensor 2200, and the puff sensor 2300 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 3000 may output information on a state of the aerosol generating device 1 and provide the information to a user. The output unit 3000 may include at least one of a display unit 3100, a haptic unit 3200, and a sound output unit 3300, but is not limited thereto. When the display unit 3100 and a touch pad form a layered structure to form a touch screen, the display unit 3100 may also be used as an input device in addition to an output device.

The display unit 3100 may visually provide information about the aerosol generating device 1 to the user. For example, information about the aerosol generating device 1 may mean various pieces of information, such as a charging/discharging state of the battery 4000 of the aerosol generating device 1, a preheating state of the heater 5000, an insertion/removal state of an aerosol generating article, or a state in which the use of the aerosol generating device 1 is restricted (e.g., sensing of an abnormal object), or the like, and the display unit 3100 may output the information to the outside. The display unit 3100 may be, for example, a liquid crystal display panel (LCD), an organic light-emitting diode (OLED) display panel, or the like. In addition, the display unit 3100 may be in the form of a light-emitting diode (LED) light-emitting device.

The haptic unit 3200 may tactilely provide information about the aerosol generating device 1 to the user by converting an electrical signal into a mechanical stimulus or an electrical stimulus. For example, the haptic unit 3200 may include a motor, a piezo-electric element, or an electrical stimulation device.

The sound output unit 3300 may audibly provide information about the aerosol generating device 1 to the user. For example, the sound output unit 3300 may convert an electrical signal into a sound signal and output the same to the outside.

The battery 4000 may supply power used to operate the aerosol generating device 1. The battery 4000 may supply power such that the heater 5000 may be heated. In addition, the battery 4000 may supply power required for operations of other components (e.g., the sensing unit 2000, the output unit 3000, the user input unit 6000, the memory 7000, and the communication unit 8000) in the aerosol generating device 1. The battery 4000 may be a rechargeable battery or a disposable battery. For example, the battery 4000 may be a lithium polymer (LiPoly) battery, but is not limited thereto.

The heater 5000 may receive power from the battery 4000 to heat an aerosol generating material. Although not illustrated in FIG. 17, the aerosol generating device 1 may further include a power conversion circuit (e.g., a direct current (DC)/DC converter) that converts power of the battery 4000 and supplies the same to the heater 5000. In addition, when the aerosol generating device 1 generates aerosols in an induction heating method, the aerosol generating device 1 may further include a DC/ alternating current (AC) that converts DC power of the battery 4000 into AC power.

The controller 1000, the sensing unit 2000, the output unit 3000, the user input unit 6000, the memory 7000, and the communication unit 8000 may each receive power from the battery 4000 to perform a function. Although not illustrated in FIG. 17, the aerosol generating device 1 may further include a power conversion circuit that converts power of the battery 4000 to supply the power to respective components, for example, a low dropout (LDO) circuit, or a voltage regulator circuit.

In an embodiment, the heater 5000 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 5000 may be implemented by a metal wire, a metal plate on which an electrically conductive track is arranged, a ceramic heating element, or the like, but is not limited thereto.

In another embodiment, the heater 5000 may be a heater of an induction heating type. For example, the heater 5000 may include a susceptor that heats an aerosol generating material by generating heat through a magnetic field applied by a coil.

The user input unit 6000 may receive information input from the user or may output information to the user. For example, the user input unit 6000 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 17, the aerosol generating device 1 may further include a connection interface, such as a universal serial bus (USB) interface, and may connect to other external devices through the connection interface, such as the USB interface, to transmit and receive information, or to charge the battery 4000.

The memory 7000 is a hardware component that stores various types of data processed in the aerosol generating device 1, and may store data processed and data to be processed by the controller 1000. The memory 7000 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 7000 may store an operation time of the aerosol generating device 1, the maximum number of puffs, the current number of puffs, at least one temperature profile, data on a user's smoking pattern, etc.

The communication unit 8000 may include at least one component for communication with another electronic device. For example, the communication unit 8000 may include a short-range wireless communication unit 8100 and a wireless communication unit 8200.

The short-range wireless communication unit 8100 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 8200 may include a cellular network communication unit, an Internet communication unit, a computer network (e.g., local area network (LAN) or wide area network (WAN)) communication unit, or the like, but is not limited thereto. The wireless communication unit 8200 may also identify and authenticate the aerosol generating device 1 within a communication network by using subscriber information (e.g., International Mobile Subscriber Identifier (IMSI)).

The controller 1000 may control general operations of the aerosol generating device 1. In an embodiment, the controller 1000 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 1000 may control the temperature of the heater 5000 by controlling supply of power of the battery 4000 to the heater 5000. For example, the controller 1000 may control power supply by controlling switching of a switching element between the battery 4000 and the heater 5000. In another example, a direct heating circuit may also control power supply to the heater 5000 according to a control command of the controller 1000.

The controller 1000 may analyze a result sensed by the sensing unit 2000 and control subsequent processes to be performed. For example, the controller 1000 may control power supplied to the heater 5000 to start or end an operation of the heater 5000 on the basis of a result sensed by the sensing unit 2000. As another example, the controller 1000 may control, based on a result sensed by the sensing unit 2000, an amount of power supplied to the heater 5000 and the time the power is supplied, such that the heater 5000 may be heated to a certain temperature or maintained at an appropriate temperature.

The controller 1000 may control the output unit 3000 on the basis of a result sensed by the sensing unit 2000. For example, when the number of puffs counted through the puff sensor 2300 reaches a preset number, the controller 1000 may notify the user that the aerosol generating device 1 will soon be terminated through at least one of the display unit 3100, the haptic unit 3200, and the sound output unit 3300.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. A heater module for an aerosol generating device, the heater module comprising:
a module main body comprising:
a heater accommodation groove for accommodating a heater configured to be detachably coupled to a cartridge containing an aerosol generating material; and
a printed circuit board (PCB) accommodation groove for accommodating a PCB unit electrically connected to an aerosol generating device;
a heater terminal arranged in the module main body, electrically connected to the heater, and configured to deliver power to the heater from a battery included in the aerosol generating device; and
a recognition terminal arranged apart from the heater terminal in the module main body and configured to be electrically connected to the PCB unit and the cartridge,
wherein at least one of the heater terminal and the recognition terminal is insert-injected into the module main body.

2. The heater module of claim 1, wherein the module main body comprises:
a recognition terminal accommodation portion for accommodating the recognition terminal; and
a waterproof partition wall separating the heater accommodation groove from the recognition terminal accommodation portion.

3. The heater module of claim 1, wherein
one portion of the heater terminal is arranged in a chamber in which an aerosol is generated and which is connected to the heater accommodation groove, and is electrically connected to the heater, and
another portion of the heater terminal passes through the module main body to be electrically connected to the battery.

4. The heater module of claim 1, wherein the heater terminal comprises:
a first heater terminal element in contact with the heater;
a second heater terminal element connected to the first heater terminal element; and
a third heater terminal element connected to the second heater terminal element and coupled to the module main body.

5. The heater module of claim 4, wherein a portion of at least one of the first heater terminal element and the second heater terminal element comprises a curved surface.

6. The heater module of claim 4, wherein the first heater terminal element is connected to the second heater terminal element to elastically move.

7. The heater module of claim 4, wherein a portion of the second heater terminal element facing the heater accommodation groove is inclined with respect to a direction in which the third heater terminal element extends.

8. The heater module of claim 4, wherein the third heater terminal element is arranged to be spaced apart from an inner surface of the module main body.

9. The heater module of claim 4, wherein the heater terminal further comprises a fourth heater terminal element connected to the third heater terminal element and extending in a direction crossing a direction in which the third heater terminal element extends.

10. The heater module of claim 4, wherein the first heater terminal element protrudes into the heater accommodation groove.

11. The heater module of claim 1, wherein the recognition terminal comprises:
a cartridge contact element configured to be in contact with the cartridge when the heater module is coupled to the cartridge;
a recognition terminal main body configured to be connected to the cartridge contact element when the heater module is coupled to the cartridge; and
a PCB contact element connected to the recognition terminal main body and the PCB unit.

12. The heater module of claim 11, wherein the cartridge contact element is arranged to surround a portion of the recognition terminal main body.

13. The heater module of claim 11, wherein the PCB contact element comprises a portion protruding toward the PCB unit.

14. The heater module of claim 1, wherein
the PCB unit comprises a PCB substrate in contact with the recognition terminal, and a memory chip arranged on the PCB substrate, and
the PCB accommodation groove comprises a first accommodation groove for accommodating the PCB substrate and a second accommodation groove for accommodating the memory chip.

15. An aerosol generating device comprising:
the heater module of claim 1;
the cartridge coupled to one side of the heater module and having a storage tank for accommodating the aerosol generating material; and
an aerosol generating device main body coupled to another side of the heater module and having the battery configured to transmit power to the heater.
